(19) United States
(12) Patent Application Publication
(10) Pub. No.: US 2026/0358914 A1
(43) Pub. Date: Nov. 12, 2026

(54) PORTABLE ELECTRONIC DEVICE FOR DRAWING

(71) Applicant: Samsung Electronics Co., Ltd., Suwon-si (KR)

(72) Inventors: Jeonghyun LEE, Suwon-si (KR); Youngjae MEEN, Suwon-si (KR); Nina LEE, Suwon-si (KR)

(21) Appl. No.: 19/727,667

(22) Filed: Jul. 1, 2026

Related U.S. Application Data
(63) Continuation of application No. PCT/KR2024/017304, filed on Nov. 5, 2024.

(30) Foreign Application Priority Data
Mar. 11, 2024 (KR) 10-2024-0034057
Apr. 26, 2024 (KR) 10-2024-0056185

(51) Int. Cl. G06F 3/038; G06F 3/01; G06F 3/0346; G06F 3/0482; G06F 3/04847; G06F 3/04883

(52) U.S. Cl. CPC G06F 3/0383; G06F 3/014; G06F 3/0346; G06F 3/0482; G06F 3/04847; G06F 3/04883; G06F 2203/0331; G06F 2203/0384

(57) ABSTRACT

A portable electronic device is provided. The portable electronic device includes a touch sensitive display, a wireless communication circuit, memory, including one or more storage media, storing instructions, and at least one processor communicatively coupled to the touch-sensitive display, the wireless communication circuit, and the memory, wherein the instructions, when executed by the at least one processor individually or collectively, cause the portable electronic device to receive, through the wireless communication circuit, data related to a pressure value from a first wearable device and data related to a first tilt value from a second wearable device, determine, based on the pressure value, a first attribute value related to a thickness of a drawing and/or a transparency of the drawing, determine a second attribute value related to gradation of the drawing based on the first tilt value, and, based on a touch input received from the touch-sensitive display, display, on the touch-sensitive display, the drawing to which the first attribute value and the second attribute value are applied.

### CROSS-REFERENCE TO RELATED APPLICATION(S)

This application is a continuation application, claiming priority under 35 U.S.C. § 365(c), of an International application No. PCT/KR 2024/017304, filed on Nov. 5, 2024, which is based on and claims the benefit of a Korean patent application number 10-2024-0034057, filed on Mar. 11, 2024, in the Ministry of Intellectual Property (MOIP), and of a Korean patent application number 10-2024-0056185, filed on Apr. 26, 2024, in the Ministry of Intellectual Property (MOIP), the disclosure of each of which is incorporated by reference herein in its entirety.

### BACKGROUND

### 1. Field

The disclosure relates to a portable electronic device which enables drawing on a display.

### 2. Background of Related Art

The display of a portable electronic device (e.g., a smartphone) may include a sensor panel (e.g., a digitizer) that is sensitive to the proximity or touch of a digital pen on the display. The electronic device may be configured such that, when a pen tip touches the display, information regarding the pressure applied to the pen tip or the display (also referred to as writing pressure) and/or the angle between the pen and the display (also referred to as the writing angle) is acquired.

The user may carry a ring-type wearable device (also called a smart ring) as an auxiliary means for supporting functions (e.g., making calls, health care, or the like) given to the portable electronic device.

The above information is provided as background information only to assist with an understanding of the disclosure. No determination has been made, and no assertion is made, as to whether any of the above might be applicable as prior art with regard to the disclosure.

### SUMMARY

In an embodiment of the disclosure, without having a sensor panel for sensing a digital pen, the portable electronic device may acquire information corresponding to a finger's writing pressure and writing angle through a wearable device worn on the finger, and may make a drawing on the display according to a touch input by using the acquired information. For example, based on data obtained from a smart ring, the portable electronic device may display a drawing result such that the user's touch on the display reflects the writing pressure and writing angle.

Aspects of the disclosure are to address at least the above-mentioned problems and/or disadvantages and to provide at least the advantages described below. Accordingly, an aspect of the disclosure is to provide a portable electronic device which enables drawing on a display.

Additional aspects will be set forth in part in the description which follows and, in part, will be apparent from the description, or may be learned by practice of the presented embodiments.

In accordance with an aspect of the disclosure, a portable electronic device is provided. The portable electronic device includes a touch-sensitive display, a wireless communication circuit, memory, including one or more storage media, storing instructions, and at least one processor communicatively coupled to the touch-sensitive display, the wireless communication circuit, and the memory, wherein the instructions, when executed by the at least one processor individually or collectively, cause the portable electronic device to receive data related to a pressure value from a first wearable device through the wireless communication circuit and receive and data related to a first inclination value from a second wearable device, based on the pressure value, determine a first attribute value regarding at least one of a thickness of a drawing and a transparency of the drawing, based on the first inclination value, determine a second attribute value regarding gradation of the drawing, and based on a touch input received from the touch-sensitive display, display a drawing to which the first attribute value and the second attribute value are applied, on the touch-sensitive display.

In accordance with another aspect of the disclosure, a method for operating a portable electronic device is provided. The method includes receiving data related to a pressure value from a first wearable device through a wireless communication circuit of the portable electronic device and receiving data related to a first inclination value from a second wearable device, determining a first attribute value regarding at least one of a thickness of a drawing and a transparency of the drawing, based on the pressure value, determining a second attribute value regarding gradation of the drawing, based on the first inclination value, and based on a touch input received from a touch-sensitive display of the portable electronic device, displaying a drawing to which the first attribute value and the second attribute value are applied on the touch-sensitive display.

In accordance with another aspect of the disclosure, one or more non-transitory computer-readable storage media storing one or more computer programs including computer-executable instructions that, when executed by at least one processor of a portable electronic device individually or collectively, cause the electronic device to perform operations is provided. The operations include receiving data related to a pressure value from a first wearable device through a wireless communication circuit of the portable electronic device and receiving data related to a first inclination value from a second wearable device, determine a first attribute value regarding at least one of a thickness of a drawing and a transparency of the drawing, based on the pressure value, determine a second attribute value regarding gradation of the drawing, based on the first inclination value, and based on a touch input received from a touch-sensitive display of the portable electronic device, displaying a drawing to which the first attribute value and the second attribute value are applied on the touch-sensitive display.

In accordance with another aspect of the disclosure, a portable electronic device (e.g., the portable electronic device 303 in FIG. 3) is provided. The portable electronic device includes a touch-sensitive display, a wireless communication circuit, at least one processor, and memory, including one or more storage media, storing instructions, wherein the instructions, when executed by the at least one processor individually or collectively, cause the portable electronic device to receive data related to a pressure value from a first wearable device through the wireless communication circuit and receive and data related to an inclination value from a second wearable device, determine an attribute value of an eraser, based on at least one of the inclination value and the pressure value, and modify a drawing displayed on the touch-sensitive display by using an eraser to which the attribute value is applied, based on a touch input received from the touch-sensitive display.

An embodiment of the disclosure may provide a portable electronic device wherein, without having a sensor panel for sensing a digital pen, information corresponding to a finger's writing pressure and writing angle is acquired through a wearable device worn on the finger, and the acquired information is used such that writing or drawing can be made on the display according to a touch input. Various other advantageous effects identified explicitly or implicitly through the disclosure is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a perspective view of a wearable device according to an embodiment of the disclosure;

FIG. 2B is a front view of a wearable device according to an embodiment of the disclosure;

FIG. 2C is an exploded perspective view of a wearable device according to an embodiment of the disclosure;

FIG. 3 is a block diagram of a drawing system using a wearable device according to an embodiment of the disclosure;

FIG. 4 is a diagram illustrating a drawing operation using an inclination value according to an embodiment of the disclosure;

FIG. 5 is a diagram illustrating a drawing operation using a pressure value according to an embodiment of the disclosure;

FIG. 6 is a diagram illustrating a drawing operation using an inclination value and a pressure value according to an embodiment of the disclosure;

FIGS. 7A, 7B, and 7C are drawings illustrating operations for configuring a usage of a wearable device in a portable electronic device according to various embodiments of the disclosure;

FIGS. 8A, 8B, 8C, 8D, 8E, 8F, 8G, 8H, and 8I are drawings illustrating operations for assigning weights to attribute values of a drawing in a portable electronic device according to various embodiments of the disclosure;

FIGS. 9A, 9B, and 9C are drawings illustrating operations for supporting a drawing preview in a portable electronic device according to various embodiments of the disclosure;

FIG. 10 is a flowchart illustrating operations of a portable electronic device for a drawing according to an embodiment of the disclosure;

FIG. 11 is a flowchart illustrating operations of a portable electronic device for a drawing according to an embodiment of the disclosure;

FIG. 12 is a flowchart illustrating operations of a portable electronic device for a drawing according to an embodiment of the disclosure;

FIG. 13 is a flowchart illustrating operations of a portable electronic device for a drawing according to an embodiment of the disclosure;

FIG. 14 is a flowchart illustrating operations of a portable electronic device for a drawing according to an embodiment of the disclosure;

FIG. 15 is a flowchart illustrating operations of a portable electronic device for a drawing according to an embodiment of the disclosure;

FIG. 16 is a flowchart illustrating operations of a portable electronic device for a drawing according to an embodiment of the disclosure;

FIG. 17 is a flowchart illustrating operations of a portable electronic device for a drawing according to an embodiment of the disclosure;

FIG. 18 is a flowchart illustrating operations of a portable electronic device for a drawing according to an embodiment of the disclosure; and

FIG. 19 is a flowchart illustrating operations of a portable electronic device for transforming a drawing according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

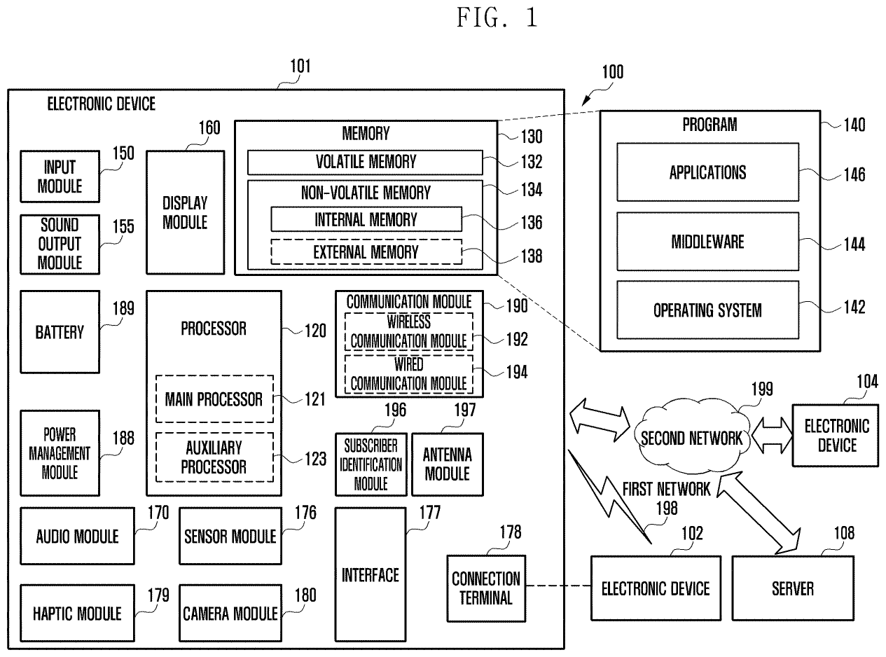

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

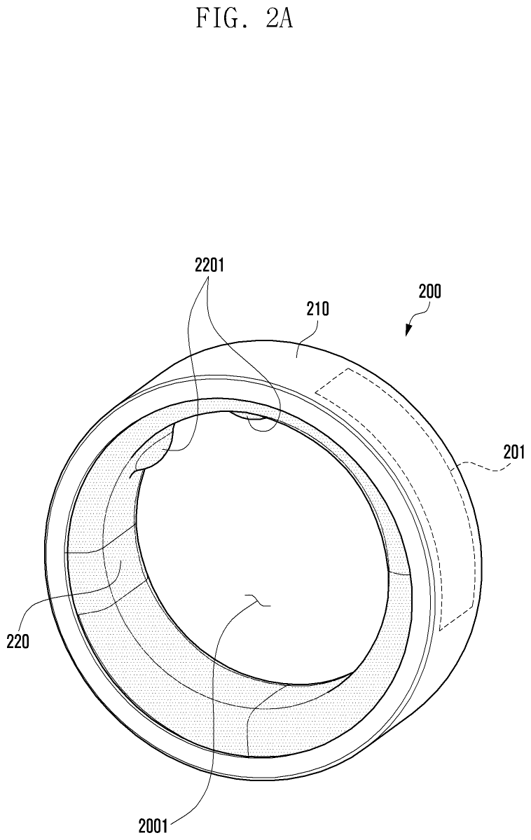

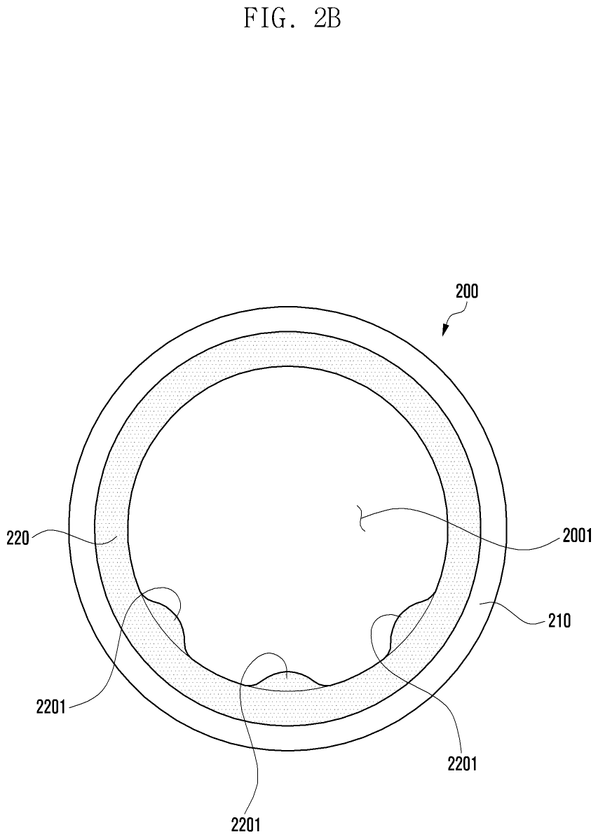

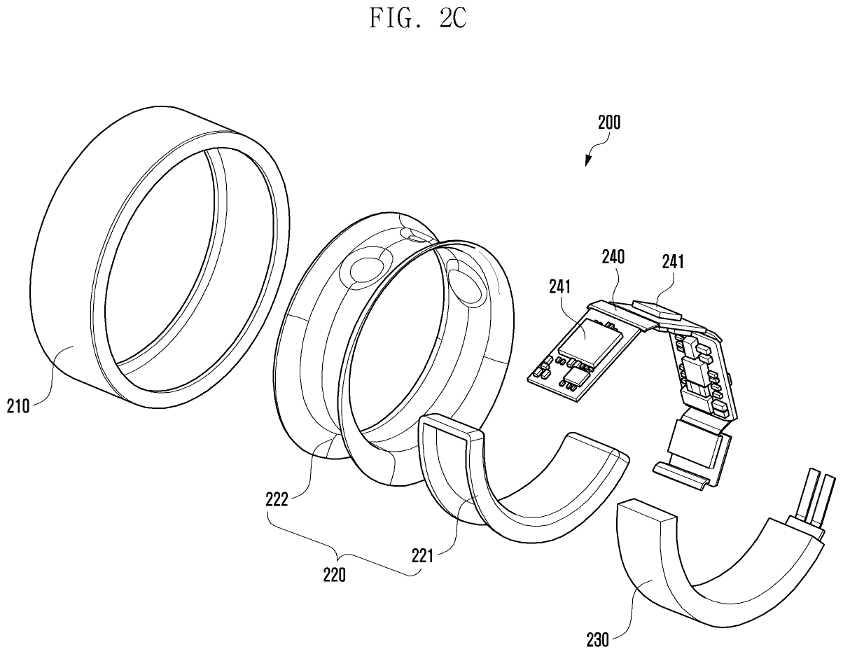

FIG. 2A is a perspective view of a wearable device according to an embodiment of the disclosure. FIG. 2B is a front view of the wearable device in FIG. 2A according to an embodiment of the disclosure. FIG. 2C is an exploded perspective view of the wearable device in FIG. 2A according to an embodiment of the disclosure. Although a ring-type wearable device 200 worn on the user's finger is illustrated and described, the disclosure is not limited thereto. For example, it is obvious to those skilled in the art that embodiments of the disclosure may be applied to a bracelet-type wearable device, an open-type ring-type electronic device which is partially open, or a curved or non-curved electronic device.

Referring to FIGS. 2A and 2B, the wearable device 200 may be formed in an annular shape to include an opening 2001 therein. In an embodiment of the disclosure, the wearable device 200 may include an annular first housing 210 (e.g., an external ring housing, a first ring housing, or a first housing portion) and an annular second housing 220 (e.g., an internal ring housing, a second ring housing, or a second housing portion) coupled to the first housing 210 and including an opening 2001. In an embodiment of the disclosure, the opening 2001 may be sized such that the user's finger can be fitted therein. In an embodiment of the disclosure, the wearable device 200 may include at least one protrusion 2201 protruding from the second housing 220 toward the opening 2001. In an embodiment of the disclosure, the at least one protrusion 2201 may be disposed in the internal space of the wearable device 200 and may be shaped to detect external environments or to contact the user's skin. In some embodiments of the disclosure, the at least one protrusion 2201 may be used as a means to prevent the wearable device 200 from inadvertently rotating on the finger.

According to an embodiment of the disclosure, the wearable device 200 may include at least one electrical element disposed in the space between the first housing 210 and the second housing 220. In an embodiment of the disclosure, the at least one electrical element may include at least one biometric sensor disposed to detect the user's biometric information through at least a part of the second housing 220, a substrate (e.g., the substrate 240 in FIG. 2A), a display 201, or an output module. In an embodiment of the disclosure, the substrate (e.g., the substrate 240 in FIG. 2C) may include a flexible printed circuit board (FPCB) which is curved to correspond to the curvature of the wearable device 200. In an embodiment of the disclosure, the display 201 may be disposed to be visible from the outside through a part (e.g., the outer peripheral surface) of the first housing 210. In an embodiment of the disclosure, the wearable device 200 may further include an indicator, such as an LED that may provide visual output information to the user. In some embodiments of the disclosure, the indicator may replace the display 201. In an embodiment of the disclosure, the display 201 may have a region formed across the front surface of the first housing 210. In an embodiment of the disclosure, the output module may include at least one speaker (not shown) for providing auditory output information to the user. In an embodiment of the disclosure, the output module may include a haptic module for providing haptic output information to the user.

Referring to FIG. 2C, the wearable device 200 may include a first housing 210, a second housing 220 coupled to the first housing 210, and a battery 230 disposed between the first housing 210 and the second housing 220. In an embodiment of the disclosure, the wearable device 200 may include a substrate 240 disposed between the first housing 210 and the second housing 220 and including multiple electrical elements 241. In an embodiment of the disclosure, the substrate 240 may include a flexible printed circuit board (FPCB) which is curved so as to correspond to the curvature of the wearable device 200. In some embodiments of the disclosure, the substrate 240 may include a substrate including a hard-type region having a width and a length configured such that the curvature of the first housing 210 and/or the second housing 220 does not interfere therewith, or multiple hard-type substrates (printed circuit boards (PCBs)). In an embodiment of the disclosure, the battery 230 may be disposed between the first housing 210 and the second housing 220 to be spaced apart from the substrate 240 by a predetermined interval, and may be electrically connected to the substrate 240 through a cable. In an embodiment of the disclosure, the battery 230 may be formed in a curved shape to have a curvature that is substantially the same as the curvature of the first housing 210. In some embodiments of the disclosure, the battery 230 may be disposed between the first housing 210 and the second housing 220 in a shape having a curvature different from the curvature of the first housing 210 and/or the curvature of the second housing 220.

According to an embodiment of the disclosure, the first housing 210 may be made of a metal material, ceramic, or a PC material. In an embodiment of the disclosure, the second housing 220 may be made of a molding material and may be coupled to the first housing 210 through a molding process. In an embodiment of the disclosure, the second housing 220 may include a first molding layer 221 disposed to cover at least a part of the battery 230, and a second molding layer 222 that covers the first molding layer 221 and is coupled to the first housing 210. In an embodiment of the disclosure, the first molding layer 221 may be disposed so as to cover the entire battery 230 and at least partially contact the inner surface of the first housing 210.

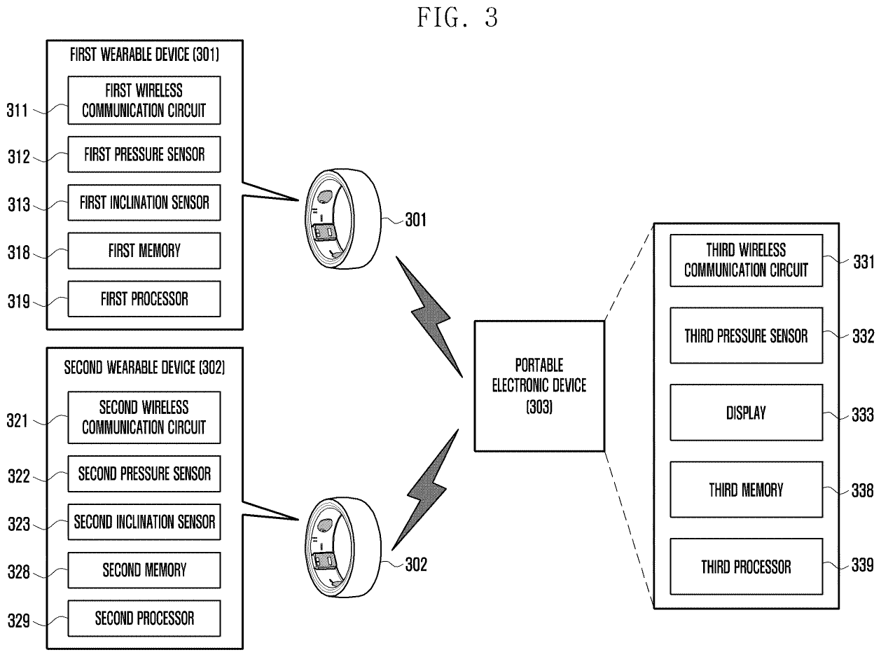

FIG. 3 is a block diagram of a drawing system using a wearable device according to an embodiment of the disclosure. Referring to FIG. 3, the drawing system may include a first wearable device 301, a second wearable device 302, and a portable electronic device 303. The electronic device 101 in FIG. 1 may correspond to the portable electronic device 303. The external electronic device 102 in FIG. 1 or the wearable device 200 in FIG. 2A may correspond to the first wearable device 301 or the second wearable device 302. The first wearable device 301 and the second wearable device 302 may be of a ring type to be worn on the user's finger (e.g., the wearable device 200 in FIG. 2A) and may be wirelessly connected to the portable electronic device 303 (e.g., the electronic device 101 in FIG. 1). The wearable devices 301 and 302 may include at least one sensor and may provide data (e.g., information regarding the inclination and/or pressure) acquired through the sensor to the portable electronic device 303.

According to an embodiment of the disclosure, the first wearable device 301 may include a first wireless communication circuit 311, a first pressure sensor 312, a first inclination sensor 313, first memory 318, and a first processor 319. The first wireless communication circuit 311, the first memory 318, and the first processor 319 may be implemented substantially identically to the wireless communication module 192, the memory 130, and the processor 120 in FIG. 1, respectively, and thus perform the same functions. The first pressure sensor 312 and the first inclination sensor 313 may be implemented substantially identically to the sensor module 176 in FIG. 1 and thus perform the same functions.

According to an embodiment of the disclosure, the first pressure sensor 312 may be configured to generate raw data used to acquire the pressure applied to the housing (e.g., the second housing 220 in FIG. 2A) of the first wearable device 301. When the first wearable device 301 is worn fitted around a finger, the pressure applied to the first wearable device 301 may change according to the degree to which the user bends the finger. The first processor 319 may be configured to acquire (e.g., calculate) a pressure value by using data received from the first pressure sensor 312.

According to an embodiment of the disclosure, the first inclination sensor 313 may be configured to generate inclination-related signals (e.g., an acceleration signal, an angular velocity signal, and a geomagnetic signal) as raw data used to acquire the inclination of the first wearable device 301. For example, the first inclination sensor 313 may include an inertial measurement unit (IMU) including an acceleration sensor, a gyroscope (also referred to as an angular velocity sensor), and a magnetometer. The acceleration sensor in the first inclination sensor 313 may be configured to generate a first acceleration value corresponding to a motion in the x-axis direction, a second acceleration value corresponding to a motion in the y-axis direction, and a third acceleration value corresponding to a motion in the z-axis direction. The gyroscope in the first inclination sensor 313 may be configured to generate a first angular velocity value corresponding to a rotational motion with respect to the x-axis, a second angular velocity value corresponding to a rotational motion with respect to the y-axis, and a third angular velocity value corresponding to a rotational motion with respect to the z-axis. The first processor 319 may acquire (e.g., calculate) inclination values (e.g., Euler angles (roll, pitch, and yaw)) by using data received from the first inclination sensor 313 (e.g., data indicating acceleration values along respective axes and data indicating the direction of the Earth's magnetic field).

According to an embodiment of the disclosure, the first processor 319 may be configured to perform an operation of acquiring data related to a pressure value (e.g., the pressure value itself or raw data of the pressure value) by using the first pressure sensor 312 and an operation of transmitting the data to the portable electronic device 303 through the first wireless communication circuit 311. The first processor 319 may be configured to perform an operation of acquiring data related to an inclination value (e.g., the inclination value itself or raw data of the inclination value) by using the first inclination sensor 313 and an operation of transmitting the data to the portable electronic device 303 through the first wireless communication circuit 311.

According to an embodiment of the disclosure, instructions may be stored in the memory of the first wearable device 301. The memory for storing the instructions may include first memory 318 and/or internal memory of the first processor 319. For example, instructions may be stored in the first memory 318 or in the internal memory of the first processor 319. As another example, instructions may be partially stored in the first memory 318 and the internal memory of the first processor 319. The instructions stored in the memory, when executed by the first processor 319, may cause the first wearable device 301 to perform the above-described operations of the first processor 319.

According to an embodiment of the disclosure, the second wearable device 302 may include a second wireless communication circuit 321, a second pressure sensor 322, a second inclination sensor 323, second memory 328, and a second processor 329. The second wireless communication circuit 321, the second memory 328, and the second processor 329 may be implemented substantially identically to the wireless communication module 192, the memory 130, and the processor 120 in FIG. 1, respectively, and thus perform the same functions. The second pressure sensor 322 and the second inclination sensor 323 may be implemented substantially identically to the sensor module 176 in FIG. 1 and thus perform the same functions.

According to an embodiment of the disclosure, the second pressure sensor 322 may be configured substantially identically to the first pressure sensor 312.

According to an embodiment of the disclosure, the second inclination sensor 323 may be configured substantially identically to the first inclination sensor 313.

According to an embodiment of the disclosure, the second processor 329 may be configured to perform an operation of acquiring data related to pressure values using the second pressure sensor 322 and an operation of transmitting the data to the portable electronic device 303 through the second wireless communication circuit 321. The second processor 329 may be configured to perform an operation of acquiring data related to inclination values using the second inclination sensor 323 and an operation of transmitting the data to the portable electronic device 303 through the second wireless communication circuit 321.

According to an embodiment of the disclosure, instructions may be stored in the memory of the second wearable device 302. The memory for storing instructions may include the second memory 328 and/or the internal memory of the second processor 329. For example, instructions may be stored in the second memory 328 or in the internal memory of the second processor 329. As another example, instructions may be partially stored in the second memory 328 and the internal memory of the second processor 329. The instructions stored in the memory, when executed by the second processor 329, may cause the second wearable device 302 to perform the above-described operations of the second processor 329.

According to an embodiment of the disclosure, the portable electronic device 303 may include a third wireless communication circuit 331, a third inclination sensor 332, a display 333 responsive to the user's touch, third memory 338, and a third processor 339. The third wireless communication circuit 331, the third inertial sensor 332, the display 333, the third memory 338, and the third processor 339 may be implemented substantially identically to the wireless communication module 192, the sensor module 176, the display module 160, the memory 130, and the processor 120 in FIG. 1, respectively, and thus perform the same functions.

According to an embodiment of the disclosure, the third inclination sensor 332 may be configured substantially identically to the first inclination sensor 313 or the second inclination sensor 323.

According to an embodiment of the disclosure, the wireless communication circuits 311, 321, and 331 may include a communication circuit for short-range wireless communication (e.g., a Bluetooth (BT) communication circuit and a Wi-Fi communication circuit). The portable electronic device 303 may establish a wireless communication channel (e.g., a Bluetooth low energy (BLE) communication channel) with an external electronic device (e.g., the first wearable device 301 and/or the second wearable device 302) through the short-range wireless communication circuit. The portable electronic device 303 may perform short-range wireless communication with the external electronic device through the established wireless communication channel. The portable electronic device 303 may recognize the proximity of an external electronic device (e.g., the first wearable device 301 or the second wearable device 302) through short-range wireless communication. For example, the third processor 399 in the portable electronic device 303 may acquire the strength of a signal received from an external electronic device by the third wireless communication circuit 331 through the third wireless communication circuit 331. The third processor 399 may determine that the external electronic device is within a specific distance, based on the signal strength (SS) being within a designated threshold, and may support a drawing operation (e.g., a drawing preview), based on such a determination.

According to an embodiment of the disclosure, instructions may be stored in the memory of the portable electronic device 303. The memory for storing instructions may include the third memory 338 and/or the internal memory of the third processor 339. For example, instructions may be stored in the third memory 338 or in the internal memory of the third processor 339. As another example, instructions may be partially stored in the internal memory of the third memory 338 and the third processor 339. The instructions stored in the memory, when executed by the third processor 339, may cause the portable electronic device 303 to perform drawing operations. Hereinafter, drawing operations of the portable electronic device 303 according to an embodiment of the disclosure will be described below. In order to understand the following operations, reference may be made to FIGS. 1, 2A, 2B, 2C, and 3.

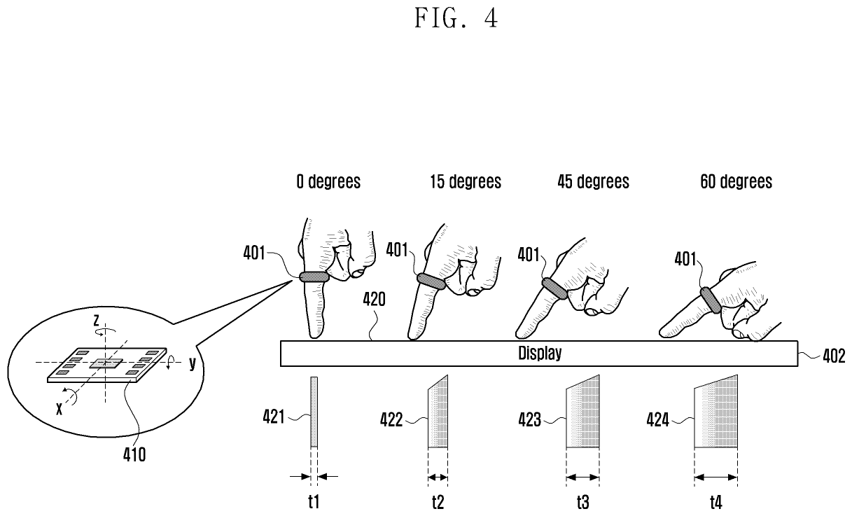

FIG. 4 is a diagram illustrating a drawing operation using an inclination value according to an embodiment of the disclosure. Referring to FIG. 4, while a wearable device 401 (e.g., the first wearable device 301 or the second wearable device 302 in FIG. 3) is fitted around a finger, the user may write characters or draw a picture on a touch-sensitive display 420 of a portable electronic device 402 (e.g., the portable electronic device 303 in FIG. 3) with the finger.

The wearable device 401 may provide data related to an inclination value acquired from the inclination sensor 410 to the portable electronic device 402. For example, the wearable device 401 may provide raw data acquired from the inclination sensor 410 to the portable electronic device 402. The portable electronic device 402 may calculate the inclination value (e.g., the angle indicating the degree to which the wearable device 401 is inclined with respect to the gravity direction) by using the provided raw data. As another example, the wearable device 401 may calculate angular velocities and/or accelerations corresponding to the x-axis, y-axis, and z-axis, respectively, using the raw data and provide the acceleration values and/or angular velocity values to the portable electronic device 402. The portable electronic device 402 may calculate the inclination value by using the provided acceleration values and/or angular velocity values. As another example, the wearable device 401 may calculate the inclination value by using the acceleration values and/or angular velocity values and may provide the inclination value itself to the portable electronic device 402.

The portable electronic device 402 may configure a first attribute value regarding a brush (e.g., a pen, a paintbrush, a pencil) selected by the user, based on the inclination value received from the wearable device 401. The portable electronic device 402 may further consider the inclination of the portable electronic device 402 in the process of configuring the first attribute value. In response to the user's touch input on the display 420, the portable electronic device 402 may display a drawing to which the first attribute value is applied on the display 420.

According to an embodiment of the disclosure, the portable electronic device 402 may configure the thickness of the drawing, based on the inclination value received from the wearable device 401. The portable electronic device 402 may display the drawing to which the configured thickness is applied on the display 420 in response to a touch input. As an example, referring to FIG. 4, if the inclination value between the y-axis and the z-axis is 0°, the thickness of the first drawing 421 is t1, if the inclination value is 15°, the thickness of the second drawing 422 is t2, which is approximately twice t1, if the inclination value is 45°, the thickness of the third drawing 423 is t3, which is approximately twice t2, and if the inclination value is 60°, the thickness of the fourth drawing 424 is t4, which is approximately three times t2.

According to an embodiment of the disclosure, the portable electronic device 402 may configure the thickness and gradation of the drawing, based on the inclination value received from the wearable device 401. The gradation may be understood as the degree to which the attribute (e.g., hue, texture, or tone) of drawing changes to another attribute. The portable electronic device 402 may display the drawing to which the determined thickness and gradation are applied on the display 420 in response to a touch input. As an example, if the inclination value is 0°, the first drawing 421 has one tone and a thickness of t1, if the inclination value is 15°, the second drawing 422 has two different tones and a thickness of t2, which is approximately twice t1, if the inclination value is 45°, the third drawing 423 has three different tones and a thickness of t3, which is approximately twice t2, and if the inclination value is 60°, the fourth drawing 424 has four different tones and a thickness of t4, which is approximately three times t2.

According to an embodiment of the disclosure, the portable electronic device 402 may configure the gradation of the drawing, based on the inclination value received from the wearable device 401. As an example, the portable electronic device 402 may configure the degree of change in tone in proportion to the inclination value. The portable electronic device 402 may display the drawing to which the configured gradation is applied on the display 420 in response to a touch input.

According to an embodiment of the disclosure, the portable electronic device 402 may configure the bleed of the drawing, based on the inclination value received from the wearable device 401. The bleed may be understood as the degree to which the drawing (e.g., brush stroke) spreads (or diffuses). For example, the portable electronic device 402 may configure the degree of diffusion of the brush stroke in proportion to the inclination value. The portable electronic device 402 may display the drawing to which the configured bleed is applied on the display 420 in response to a touch input.

According to an embodiment of the disclosure, the portable electronic device 402 may configure the bleed and gradation of the drawing, based on the inclination value received from the wearable device 401. The portable electronic device 402 may display the drawing to which the configured bleed and gradation are applied on the display 420 in response to a touch input.

According to an embodiment of the disclosure, the portable electronic device 402 may configure the thickness and bleed of the drawing, based on the inclination value received from the wearable device 401. The portable electronic device 402 may display the drawing to which the configured thickness and bleed are applied on the display 420 in response to a touch input.

According to an embodiment of the disclosure, the portable electronic device 402 may configure the thickness, bleed, and gradation of the drawing, based on the inclination value received from the wearable device 401. The portable electronic device 402 may display the drawing to which the configured thickness, bleed, and gradation are applied on the display 420 in response to a touch input.

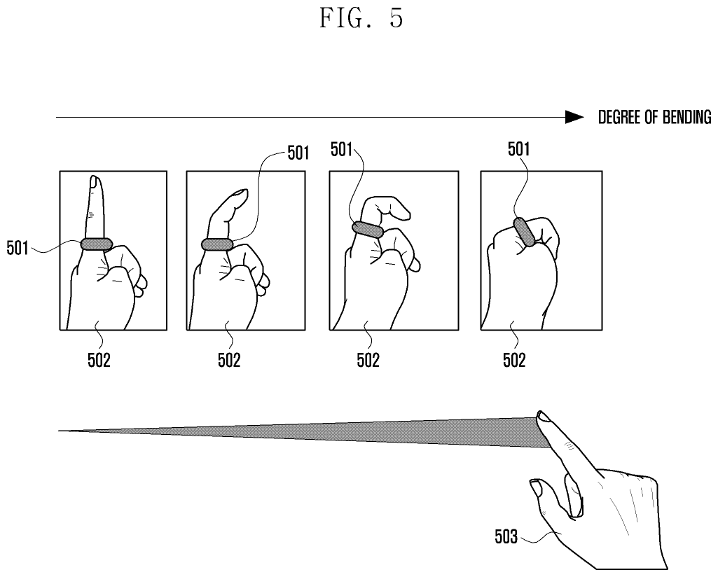

FIG. 5 is a diagram illustrating a drawing operation using pressure values according to an embodiment of the disclosure. Descriptions already made with reference to FIG. 4 will be abbreviated or omitted. Referring to FIG. 5, while fitting a wearable device 501 (e.g., the first wearable device 301 or the second wearable device 302 in FIG. 3) around one finger (e.g., the index finger of the left hand 502), the user may use another finger (e.g., the index finger of the right hand 503) to write characters or draw a picture on a touch-sensitive display of a portable electronic device (e.g., the portable electronic device 303 in FIG. 3).

The wearable device 501 may provide data related to the pressure value acquired from the pressure sensor to the portable electronic device. For example, the wearable device 501 may provide raw data acquired from the pressure sensor to the portable electronic device. The portable electronic device may calculate a pressure value by using the received raw data. As another example, the wearable device 501 may calculate a pressure value by using the raw data and provide the same to the portable electronic device.

The portable electronic device may determine a second attribute value regarding a brush (e.g., a pen, a paintbrush, a pencil) selected by the user, based on the pressure value. The portable electronic device may display the drawing to which the second attribute value is applied on the display in response to the user's touch input on the display.

According to an embodiment of the disclosure, the pressure value calculated by the wearable device 501 or the portable electronic device may increase in proportion to the degree to which the user bends his/her finger. Referring to FIG. 5, the portable electronic device may configure the thickness of the drawing in proportion to the pressure value. In response to a touch input by the right hand 503, the portable electronic device may display the drawing to which the configured thickness is applied on the display.

According to an embodiment of the disclosure, the portable electronic device may configure the transparency of the drawing, based on the pressure value. For example, the portable electronic device may configure the transparency of the drawing in proportion to the pressure value. As another example, the portable electronic device may configure the transparency of the drawing in inverse proportion to the pressure value. The portable electronic device may display the drawing to which the configured transparency is applied on the display in response to a touch input.

According to an embodiment of the disclosure, the portable electronic device 402 may configure the bleed of the drawing, based on the pressure value. For example, the portable electronic device may configure the degree of diffusion of the brush stroke in proportion to the pressure value. The portable electronic device 402 may display the drawing to which the configured bleed is applied on the display in response to a touch input.

According to an embodiment of the disclosure, the portable electronic device 402 may configure a second attribute value including at least two from among the thickness, transparency, and bleed, based on the pressure value. In response to the user's touch input on the display, the portable electronic device may display the drawing to which at least two from among the thickness, transparency, and bleed are applied on the display.

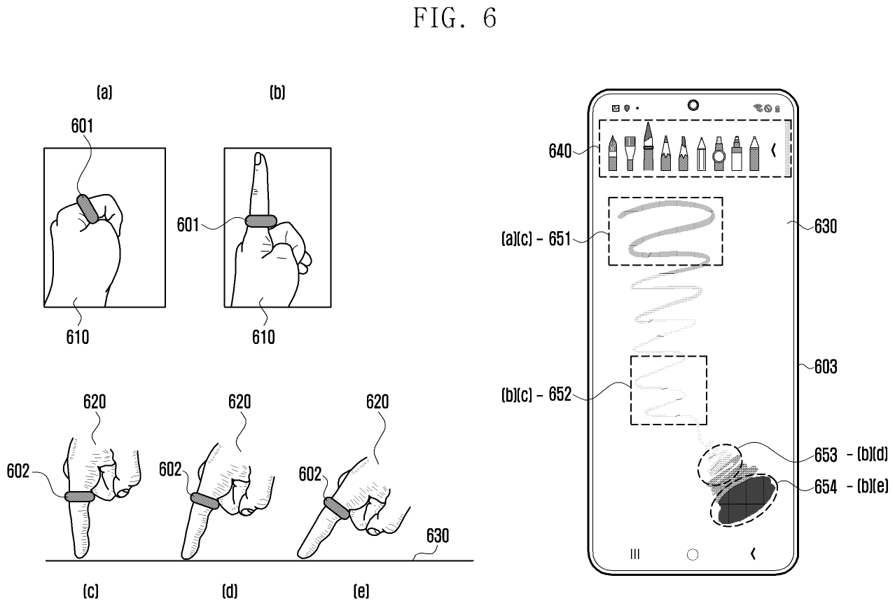

FIG. 6 is a diagram illustrating a drawing operation using an inclination value and a pressure value according to an embodiment of the disclosure. Descriptions already made with reference to FIGS. 4 and 5 will be abbreviated or omitted. Referring to FIG. 6, while a first wearable device 601 (e.g., the first wearable device 301 in FIG. 3) is fitted around one finger (e.g., the index finger of the left hand 610) and a second wearable device 602 (e.g., the second wearable device 302 in FIG. 3) is fitted around another finger (e.g., the index finger of the right hand 620), the user may write characters or draw a picture on the touch-sensitive display 630 of the portable electronic device 603 (e.g., the portable electronic device 303 in FIG. 3) with the finger around which the second wearable device 602 is fitted.

The first wearable device 601 may provide data related to the pressure value acquired from the pressure sensor to the portable electronic device 603. The second wearable device 602 may provide data related to the inclination value acquired from the inclination sensor to the portable electronic device 603.

According to an embodiment of the disclosure, the portable electronic device 603 may configure a first attribute value (e.g., bleed and/or gradation) of a brush (e.g., pen, paintbrush, or pencil) selected by the user from the brush list 640, based on the inclination value. The portable electronic device 402 may configure a second attribute value (e.g., thickness and/or transparency) of the brush (e.g., pen, paintbrush, or pencil) selected by the user, based on the pressure value. The portable electronic device 603 may display the drawing to which the first attribute value and the second attribute value are applied on the display 630, based on a touch input received from the display 630.

As an example, the portable electronic device 603 may acquire a first pressure value corresponding to state (a) (e.g., fully bent state) of the finger 610. When making a drawing with the selected brush, the portable electronic device 603 may configure the thickness of the drawing to a first thickness value (e.g., a maximum value) corresponding to the first pressure value. When making a drawing with the selected brush, the portable electronic device 603 may configure the transparency of the drawing to a first transparency value (e.g., 0% transparency) corresponding to the first pressure value. The portable electronic device 603 may acquire a first inclination value corresponding to state (c) (e.g., 0-degree inclination) of the finger 620. When making a drawing with the selected brush, the portable electronic device 603 may configure the bleed of the drawing to a first bleed value (e.g., 0%) corresponding to the first inclination value. When making a drawing with the selected brush, the portable electronic device 603 may configure the gradation of the drawing to a first gradation value (e.g., 0%) corresponding to the first inclination value. In the state (a)(c), the portable electronic device 603 may receive a first touch input from the display 630. In response to the first touch input, the portable electronic device 603 may display a first drawing 651 corresponding to state (a)(c), to which the first thickness value, first transparency value, first bleed value, and first gradation value are applied on the display 630.

As another example, the portable electronic device 603 may acquire a second pressure value corresponding to state (b) (e.g., fully stretched state) of the finger 610. The portable electronic device 603 may configure the thickness of the drawing to a second thickness value (e.g., a minimum value) corresponding to the second pressure value. The portable electronic device 603 may determine the transparency of the drawing to be a second transparency value (e.g., 50% transparency) corresponding to the second pressure value. In state (b)(c), the portable electronic device 603 may receive a second touch input from the display 630. In response to the second touch input, the portable electronic device 603 may display a second drawing 652 corresponding to state (b)(c), to which the second thickness value, second transparency value, first bleed value, and first gradation value are applied, on the display 630.

As another example, the portable electronic device 603 may acquire a second inclination value corresponding to state (d) (e.g., an inclination of 15 degrees) of the finger 620. The portable electronic device 603 may configure the bleed of the drawing to a second bleed value (e.g., 15%) corresponding to the second inclination value. The portable electronic device 603 may have the gradation of the drawing set to a second gradation value (e.g., 15%) corresponding to the second inclination value. In state (b)(d), the portable electronic device 603 may receive a third touch input from the display 630. In response to the third touch input, the portable electronic device 603 may display a third drawing 653 corresponding to state (b)(d), to which the second thickness value, second transparency value, second bleed value, and second gradation value are applied, on the display 630.

As another example, the portable electronic device 603 may acquire a third inclination value corresponding to state (e) of the finger 620 (e.g., an inclination of 45 degrees). The portable electronic device 603 may configure the bleed of the drawing to a third bleed value (e.g., 45%) corresponding to the third inclination value. The portable electronic device 603 may configure the gradation of the drawing to a third gradation value (e.g., 45%) corresponding to the third inclination value. In state (e), the portable electronic device 603 may receive a fourth touch input from the display 630. In response to the fourth touch input, the portable electronic device 603 may display a fourth drawing 654 corresponding to state (b)(e), to which the second thickness value, second transparency value, third bleed value, and third gradation value are applied, on the display 630.

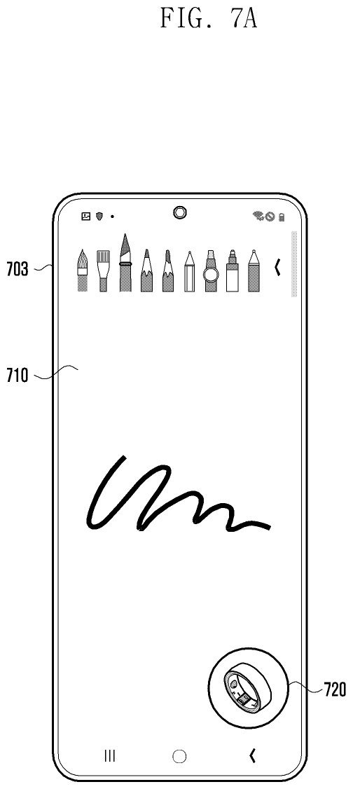

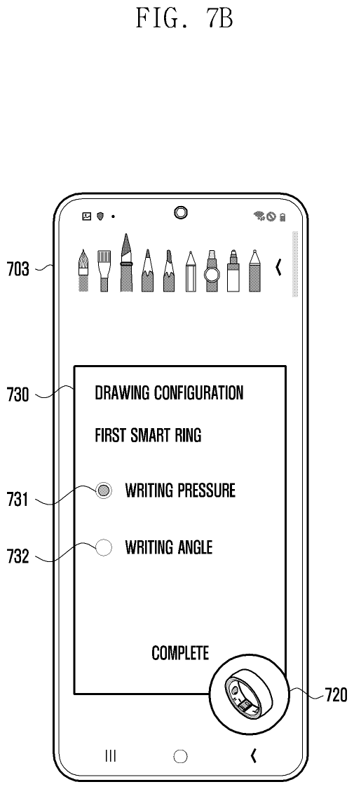

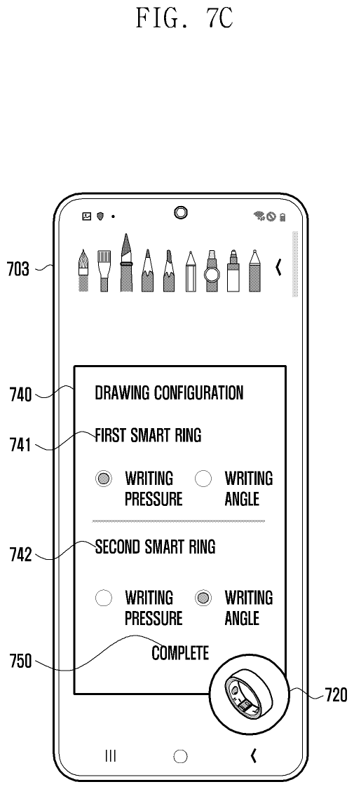

FIGS. 7A, 7B, and 7C are drawings illustrating operations for configuring the usage of a wearable device in a portable electronic device according to various embodiments of the disclosure.

Referring to FIG. 7A, the portable electronic device 703 (e.g., the portable electronic device 303 in FIG. 3) may display an execution screen 710 of an application that supports drawing. Based on the execution of the drawing support application, the portable electronic device 703 may display an icon 720 corresponding to a user interface (UI) screen for configuring the usage of the wearable device (e.g., the first wearable device 301 and/or the second wearable device 302 in FIG. 3) together with the execution screen 710. In some embodiments of the disclosure, based on the wearable device being connected to the portable electronic device 703 through a wireless communication circuit (e.g., a wireless communication channel being established for data communication between the portable electronic device 703 and the wearable device), the portable electronic device 703 may display an icon corresponding to a UI screen for the usage configuration. For example, the portable electronic device may display the icon together with an execution screen 710 or a home screen (e.g., a screen including an icon corresponding to an application). In an embodiment of the disclosure, the portable electronic device 703 may display the icon 720 in a floating state. The floating state may be defined as a state in which the corresponding object is displayed on a higher layer than other objects. For example, the portable electronic device 703 may render and display the execution screen 710 and the icon 720 on the display such that the icon 720 is positioned on a higher layer than the execution screen 710. In an embodiment of the disclosure, the portable electronic device 703 may vary the position of the icon 720 based on a user input. For example, the portable electronic device 703 may move the icon 720 from the position in FIG. 7A to another position in response to the user's touch input.

Referring to FIG. 7B, in response to a touch input regarding the icon 720, the portable electronic device 703 may display a UI screen 730 for the drawing configuration of the first smart ring (e.g., the first wearable device 301). For example, the portable electronic device 703 may configure a device, the device type of which is identified as a ring, among the devices registered in the portable electronic device 703 as the first smart ring for the drawing configuration. As another example, the portable electronic device 703 may configure a device, the device type of which is identified as a ring, among the devices connected to the portable electronic device 703 as the first smart ring for the drawing configuration. The portable electronic device 703 may display a UI screen 730 such that the user can select which drawing attribute between the writing pressure 731 and the writing angle 732 is to be recognized by using the first smart ring. As illustrated, if the writing pressure 731 is selected, the portable electronic device 703 may acquire a pressure value from data received from the first smart ring and, based on the acquired pressure value, configure a first attribute value (e.g., thickness and/or transparency) regarding the brush (e.g., pen, paintbrush, or pencil) selected by the user.

Referring to FIG. 7C, the portable electronic device 703 may, in response to a touch input on the icon 720, display a UI screen 740 for the drawing configuration of the first smart ring 741 (e.g., the first wearable device 301) and the second smart ring 742 (e.g., the second wearable device 302). For example, the portable electronic device 703 may determine two devices, the device type of which is identified as a ring, among the devices registered in the portable electronic device 703 as the first smart ring 741 and a second smart ring 742 for the drawing configuration. As another example, the portable electronic device 703 may determine two devices, the device type of which is identified as a ring, among the devices connected to the portable electronic device 703 as the first smart ring 741 and a second smart ring 742 for the drawing configuration. The portable electronic device 703 may display a UI screen 740 such that the user can select which drawing attribute between the writing pressure and the writing angle is to be recognized by using the first smart ring 741 and the second smart ring 742, respectively. As illustrated, if the first smart ring 741 is selected for writing pressure recognition, the portable electronic device 703 may acquire a pressure value from the data received from the first smart ring 741 and, based on the acquired pressure value, configure a first attribute value (e.g., thickness and/or transparency) regarding the brush (e.g., pen, paintbrush, or pencil) selected by the user. As illustrated, if the second smart ring 742 is selected for writing angle recognition, the portable electronic device 703 may acquire an inclination value from the data received from the second smart ring 742 and, based on the acquired inclination value, configure a second attribute value (e.g., bleed and/or gradation) regarding the brush (e.g., pen, paintbrush, or pencil) selected by the user.

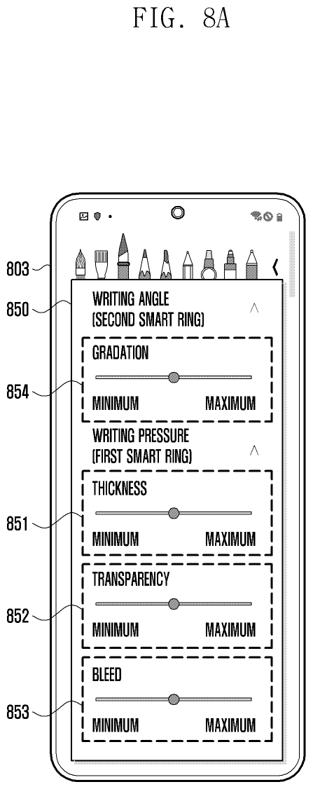

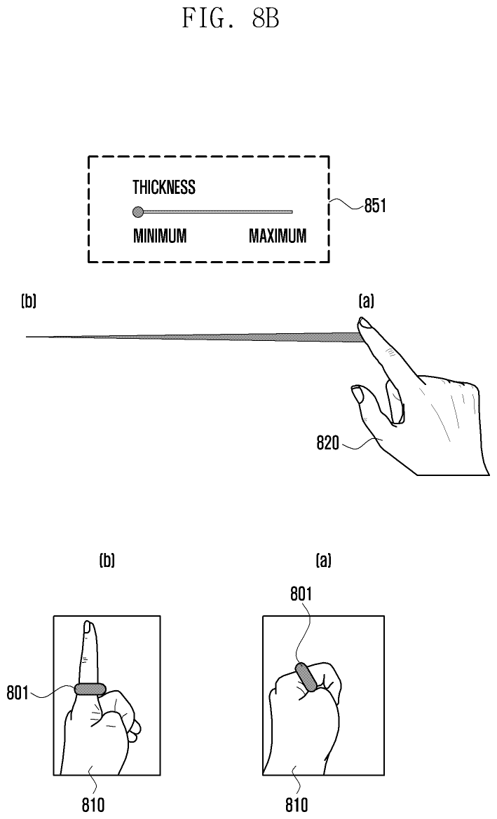

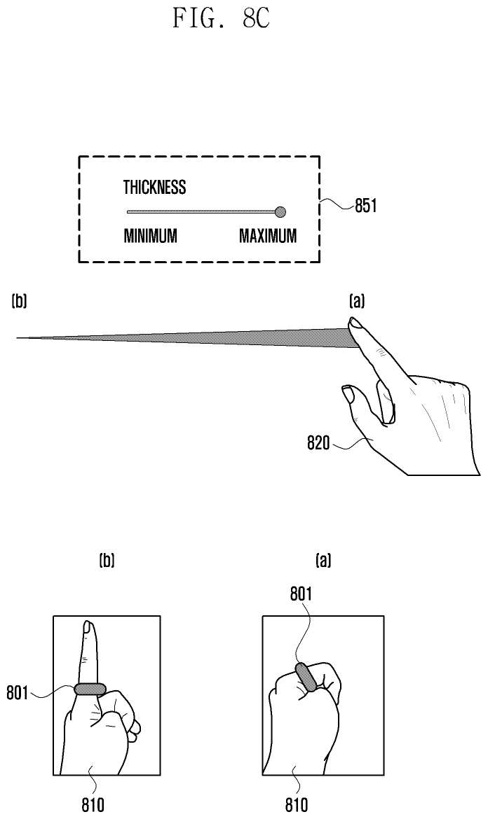

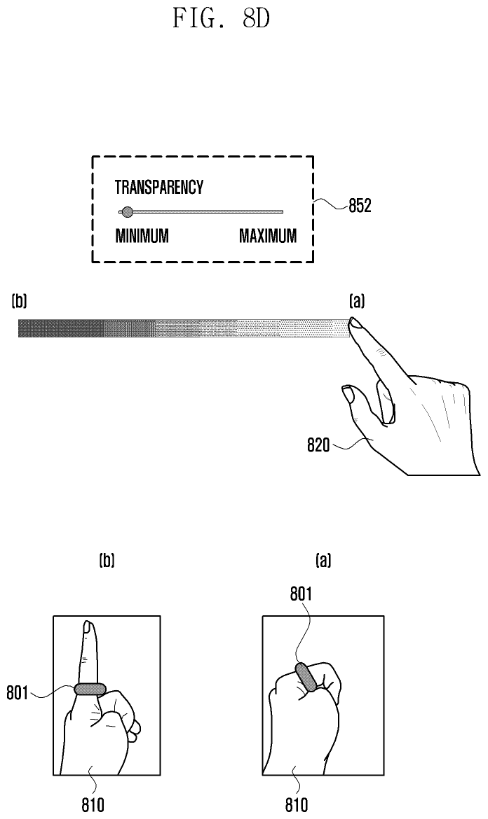

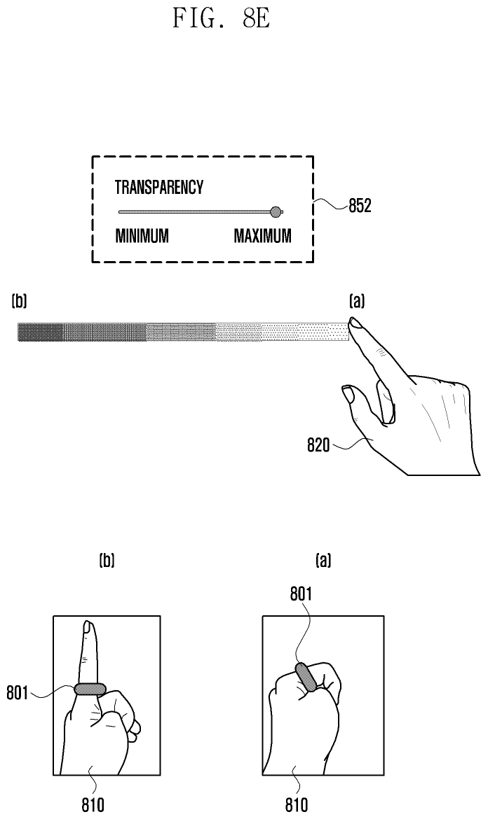

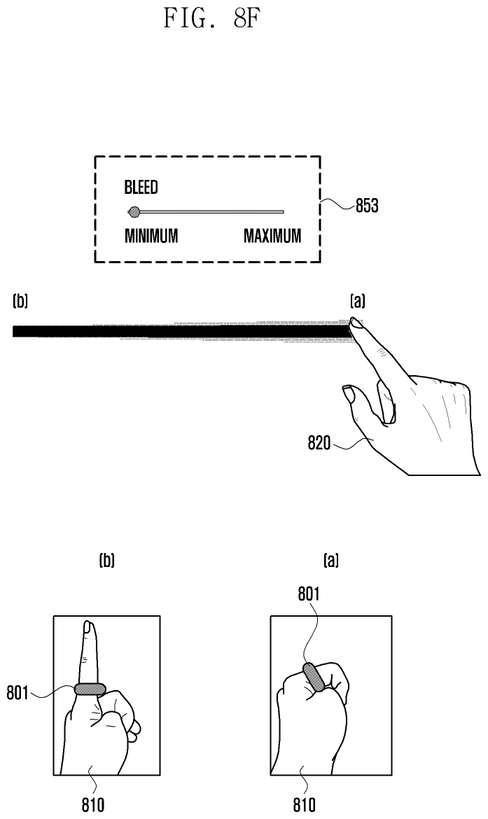

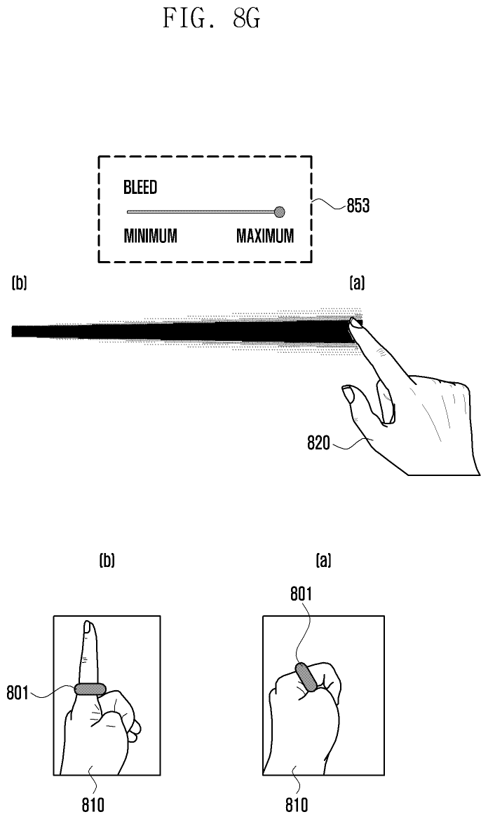

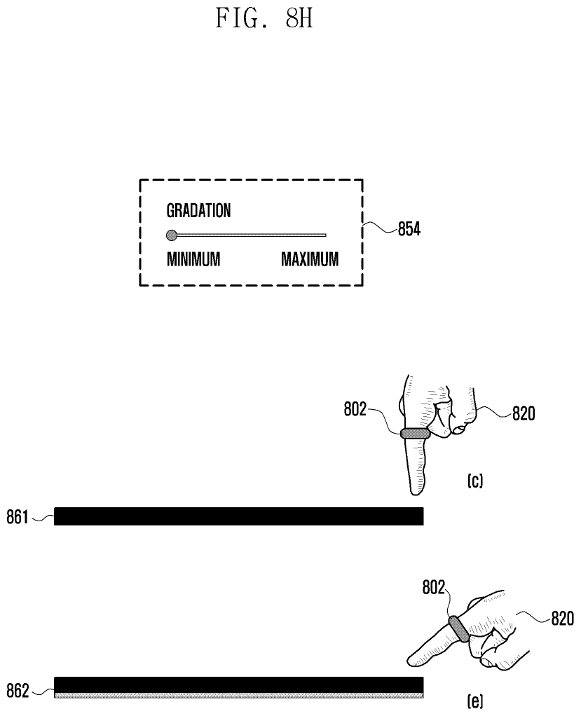

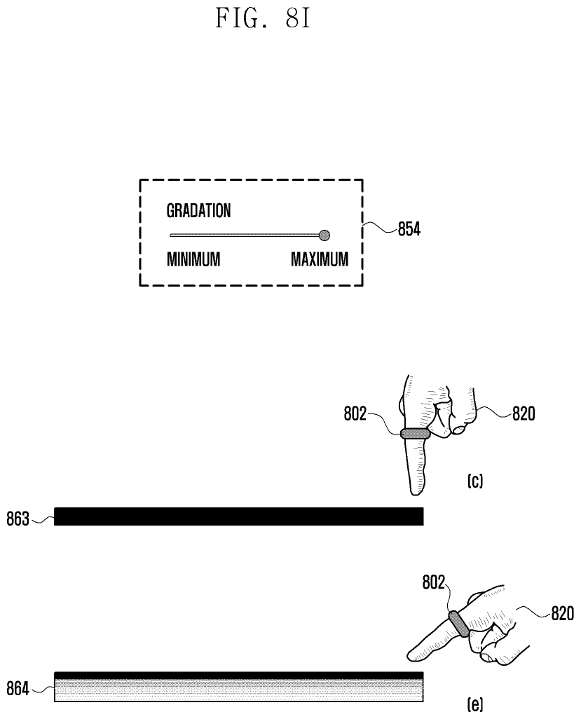

FIGS. 8A, 8B, 8C, 8D, 8E, 8F, 8G, 8H, and 8I are drawings illustrating operations for assigning weights to attribute values of a drawing in a portable electronic device according to various embodiments of the disclosure.

Referring to FIG. 8A, the portable electronic device 803 (e.g., the portable electronic device 303 of FIG. 3) may display a UI screen 850 for configuring a weight to be assigned to a first attribute value (e.g., thickness, bleed, or transparency) and/or a weight to be assigned to a second attribute value (gradation).

According to an embodiment of the disclosure, after the operation for configuring the usage of the wearable device is completed, the portable electronic device 803 may display a UI screen 850 in response to the user's touch input regarding an icon (e.g., the icon 720 in FIG. 7C) or a completion button (e.g., the completion button 750 in FIG. 7C). For example, the first smart ring (e.g., the first wearable device 301) may be configured to be used for writing angle recognition, and the second smart ring (e.g., the second wearable device 302) may be configured to be used for writing pressure recognition. Based on such configurations, the portable electronic device 803 may display a UI screen 850 including a first scroll bar 851 for configuring a weight to be assigned to the thickness of the drawing based on the pressure value acquired through the first smart ring, a second scroll bar 852 for configuring a weight to be assigned to the transparency of the drawing based on the pressure value, and a third scroll bar 853 for configuring a weight to be assigned to the bleed of the drawing based on the pressure value. In addition, the portable electronic device 803 may display a UI screen 850 including a fourth scroll bar 854 for configuring a weight to be assigned to the gradation of the drawing based on the inclination value.

According to an embodiment of the disclosure, the portable electronic device 803 may perform the usage configuring after the weighting configuration. For example, in response to the user's touch input on an icon (e.g., icon 720 in FIG. 7A), the portable electronic device 803 may display at least one of a first scroll bar for configuring the weight to be assigned to the thickness, a second scroll bar for configuring the weight to be assigned to the transparency, a third scroll bar for configuring the weight to be assigned to the bleed, and a fourth scroll bar for configuring the weight to be assigned to the gradation, on the display. The portable electronic device 803 may display a UI screen (e.g., the UI screen 740 in FIG. 7C) for usage configuration after the corresponding weight is configured through such a scroll bar.

According to an embodiment of the disclosure, the portable electronic device 803 may configure a thickness value to be applied to the drawing, based on the pressure value received from the first smart ring and the weight configured through the first scroll bar 851.

As an example, referring to FIG. 8B, the portable electronic device (e.g., the portable electronic device 303 in FIG. 3) may configure a minimum weight to be applied to the thickness of the drawing, based on a user input received through the first scroll bar 851. While the minimum thickness weight is configured, the portable electronic device may acquire a second pressure value corresponding to state (b) (e.g., fully stretched state) from the first smart ring 801 worn on one finger (e.g., the index finger of the left hand 810). The portable electronic device may determine the thickness of the drawing to be a second thickness value (e.g., a minimum thickness value) corresponding to the second pressure value. The portable electronic device may assign a minimum thickness weight to the second thickness value and thus acquire a third thickness value. In case that the configured range of weights is, for example, 0.5 (minimum) to 2 (maximum), the portable electronic device may multiply the second thickness value by 0.5 (minimum), thereby acquiring a third thickness value smaller than the second thickness value. In response to a touch input through another finger (e.g., the index finger of the right hand 820) received from the display, the portable electronic device may display the drawing to which the third thickness value is applied on the display. While the minimum thickness weight is configured, the portable electronic device may acquire a first pressure value corresponding to state (a) (e.g., a fully bent state) from the first smart ring 801. The portable electronic device may determine the thickness of the drawing to be a first thickness value (e.g., a maximum thickness value) corresponding to the first pressure value. The portable electronic device may assign a minimum thickness weight to the first thickness value and thus acquire a fourth thickness value. In response to a touch input received from the display, the portable electronic device may display the drawing to which the fourth thickness value is applied on the display.

As another example, referring to FIG. 8C, the portable electronic device (e.g., the portable electronic device 303 of FIG. 3) may configure a maximum weight to be applied to the thickness of the drawing, based on a user input received through the first scroll bar 851. While the maximum thickness weight is configured, the portable electronic device may acquire a second pressure value corresponding to state (b) (e.g., a fully stretched state) from the first smart ring 801 worn on one finger (e.g., the index finger of the left hand 810). The portable electronic device may determine the thickness of the drawing to be a second thickness value (e.g., a minimum thickness value) corresponding to the second pressure value. The portable electronic device may assign the maximum thickness weight to the second thickness value and thus acquire a fifth thickness value. In case that the configured range of weights is, for example, 0.5 (minimum) to 2 (maximum), the portable electronic device 803 may acquire a fifth thickness value that is greater than the second thickness value by multiplying the second thickness value by 2 (maximum). In response to a touch input from another finger (e.g., the index finger of the right hand 820) received from the display, the portable electronic device may display the drawing to which the fifth thickness value is applied on the display. While the maximum thickness weight is configured, the portable electronic device may acquire a first pressure value corresponding to state (a) (e.g., fully bent state) from the first smart ring 801. The portable electronic device may configure the thickness of the drawing to a first thickness value (e.g., a maximum thickness value) corresponding to the first pressure value. The portable electronic device may assign the maximum thickness weight to the first thickness value and thus acquire a sixth thickness value. The portable electronic device may display the drawing to which the sixth thickness value is applied on the display in response to a touch input received from the display.

According to an embodiment of the disclosure, the portable electronic device 803 may configure a transparency value to be applied to the drawing, based on a pressure value received from the first smart ring and a weight configured through the second scroll bar 852.

As an example, referring to FIG. 8D, the portable electronic device (e.g., the portable electronic device 303 of FIG. 3) may configure a minimum weight to be applied to the transparency of the drawing, based on a user input received through the second scroll bar 852. While the minimum transparency weight is configured, the portable electronic device may acquire a second pressure value corresponding to state (b) (e.g., a full stretched state) from the first smart ring 801 worn on one finger (e.g., the index finger of the left hand 810). The portable electronic device may determine the transparency of the drawing to be a second transparency value (e.g., a minimum transparency value) corresponding to the second pressure value. The portable electronic device may assign a minimum transparency weight to the second transparency value and thus acquire a third transparency value. In case that the configured range of weights is, for example, 0.5 (minimum) to 2 (maximum), the portable electronic device may acquire a third transparency value that is smaller than the second transparency value by multiplying the second transparency value by 0.5 (minimum). In response to a touch input from another finger (e.g., the index finger of the right hand 820) received from the display, the portable electronic device may display the drawing to which the third transparency value is applied on the display. While the minimum transparency weight is configured, the portable electronic device may acquire a first pressure value corresponding to state (a) (e.g., a fully bent state) from the first smart ring 801. The portable electronic device may determine the transparency of the drawing to be a first transparency value (e.g., a maximum transparency value) corresponding to the first pressure value. The portable electronic device may assign a minimum transparency weight to the first transparency value and thus acquire a fourth transparency value. The portable electronic device may display the drawing to which the fourth transparency value is applied on the display in response to a touch input received from the display.

As another example, referring to FIG. 8E, the portable electronic device (e.g., the portable electronic device 303 of FIG. 3) may configure a maximum weight to be applied to the transparency of the drawing, based on a user input received through the second scroll bar 852. While the maximum transparency weight is configured, the portable electronic device may acquire a second pressure value corresponding to state (b) (e.g., fully stretched state) from the first smart ring 801 worn on one finger (e.g., the index finger of the left hand 810). The portable electronic device may determine the transparency of the drawing to be a second transparency value (e.g., a minimum transparency value) corresponding to the second pressure value. The portable electronic device may assign the maximum transparency weight to the second transparency value and thus acquire a fifth transparency value. In case that the configured range of weights is, for example, 0.5 (minimum) to 2 (maximum), the portable electronic device 803 may acquire a fifth transparency value greater than the second transparency value by multiplying the second transparency value by 2 (maximum). In response to a touch input from another finger (e.g., the index finger of the right hand 820) received from the display, the portable electronic device may display the drawing to which the fifth transparency value is applied on the display. While the maximum transparency weight is configured, the portable electronic device may acquire a first pressure value corresponding to state (a) (e.g., fully bent state) from the first smart ring 801. The portable electronic device may configure the transparency of the drawing to a first transparency value (e.g., a maximum transparency value) corresponding to the first pressure value. The portable electronic device may assign the maximum transparency weight to the first transparency value and thus acquire the sixth transparency value. In response to a touch input received from the display, the portable electronic device may display the drawing to which the sixth transparency value is applied on the display.

According to an embodiment of the disclosure, the portable electronic device 803 may configure a bleed value to be applied to the drawing, based on a pressure value received from the first smart ring and a weight configured through the third scroll bar 853.

As an example, referring to FIG. 8F, the portable electronic device (e.g., the portable electronic device 303 of FIG. 3) may configure a minimum weight to be applied to the bleed of the drawing, based on a user input received through the third scroll bar 853. While the minimum bleed weight is configured, the portable electronic device may acquire a second pressure value corresponding to state (b) (e.g., fully stretched state) from the first smart ring 801 worn on one finger (e.g., the index finger of the left hand 810). The portable electronic device may determine the bleed of the drawing to be a second bleed value (e.g., a minimum bleed value) corresponding to the second pressure value. The portable electronic device may assign the minimum bleed weight to the second bleed value and thus acquire a third bleed value. In case that the configured range of weights is, for example, 0.5 (minimum) to 2 (maximum), the portable electronic device may acquire a third bleed value smaller than the second bleed value by multiplying the second bleed value by 0.5 (minimum). In response to a touch input from another finger (e.g., the index finger of the right hand 820) received from the display, the portable electronic device may display the drawing to which the third bleed value is applied on the display. While the minimum bleed weight is configured, the portable electronic device may acquire a first pressure value corresponding to state (a) (e.g., a fully bent state) from the first smart ring 801. The portable electronic device may determine the bleed of the drawing as a first bleed value (e.g., a maximum bleed value) corresponding to the first pressure value. The portable electronic device may assign a minimum bleed weight to the first bleed value and thus acquire a fourth bleed value. In response to a touch input received from the display, the portable electronic device may display the drawing to which the fourth bleed value is applied on the display.

As another example, referring to FIG. 8G, the portable electronic device (e.g., the portable electronic device 303 of FIG. 3) may configure a maximum weight applied to the bleed of the drawing, based on a user input received through the third scroll bar 853. While the maximum bleed weight is configured, the portable electronic device may acquire a second pressure value corresponding to state (b) (e.g., fully stretched state) from the first smart ring 801 worn on one finger (e.g., the index finger of the left hand 810). The portable electronic device may determine the bleed of the drawing as a second bleed value (e.g., the minimum bleed value) corresponding to the second pressure value. The portable electronic device may assign the maximum bleed weight to the second bleed value and thus acquire a fifth bleed value. In case that the configured range of weights is, for example, 0.5 (minimum) to 2 (maximum), the portable electronic device 803 may acquire a fifth bleed value that is greater than the second bleed value by multiplying the second bleed value by 2 (maximum). In response to a touch input from another finger (e.g., the index finger of the right hand 820) received from the display, portable electronic device may display the drawing to which the fifth bleed value is applied on the display. While the maximum bleed weight is configured, the portable electronic device may acquire a first pressure value corresponding to the state (a) (e.g., a fully bent state) from the first smart ring 801. The portable electronic device may configure the bleed of the drawing to a first bleed value (e.g., a maximum bleed value) corresponding to the first pressure value. The portable electronic device may assign the maximum bleed weight to the first bleed value and thus acquire the sixth bleed value. In response to a touch input received from the display, the portable electronic device may display the drawing to which the sixth bleed value is applied on the display.

According to an embodiment of the disclosure, the portable electronic device 803 may configure a gradation value to be applied to the drawing, based on an inclination value received from the second smart ring and a weight configured through the fourth scroll bar 854.

As an example, referring to FIG. 8H, the portable electronic device (e.g., the portable electronic device 303 in FIG. 3) may configure a minimum weight to be applied to the gradation of the drawing, based on a user input received through the fourth scroll bar 854. While the minimum gradation weight is configured, the portable electronic device may acquire a first inclination value corresponding to state (c) (e.g., 0-degree inclination) from the second smart ring 802 worn on one finger (e.g., the index finger of the right hand 820). The portable electronic device may determine the gradation of the drawing to be a first gradation value (e.g., the minimum gradation value) corresponding to the first inclination value. The portable electronic device may assign the minimum gradation weight to the first gradation value and thus acquire a second gradation value. In case that the configured range of weights is, for example, 0.5 (minimum) to 2 (maximum), the portable electronic device may acquire a second gradation value that is smaller than the first gradation value by multiplying the first gradation value by 0.5 (minimum). In response to a touch input by a finger (e.g., the index finger of the right hand 820) received from the display, the portable electronic device may display the drawing 861 to which the second gradation value is applied on the display. While the minimum gradation weight is configured, the portable electronic device may acquire a third inclination value corresponding to state (e) (e.g., 45-degree inclination) from the second smart ring 802. The portable electronic device may determine the gradation of the drawing as a third gradation value (e.g., the maximum gradation value) corresponding to the third inclination value. The portable electronic device may assign the minimum gradation weight to the third gradation value and thus acquire a fourth gradation value. In response to a touch input received from the display, the portable electronic device may display the drawing 862 to which the fourth gradation value is applied on the display.

As another example, referring to FIG. 8I, the portable electronic device (e.g., the portable electronic device 303 of FIG. 3) may configure a maximum weight to be applied to the gradation of the drawing, based on a user input received through the fourth scroll bar 854. While the maximum gradation weight is configured, the portable electronic device may acquire a first inclination value corresponding to state (c) (e.g., 0-degree inclination) from the second smart ring 802 worn on one finger (e.g., the index finger of the right hand 820). The portable electronic device may determine the gradation of the drawing to be the first gradation value (e.g., the minimum gradation value) corresponding to the first inclination value. The portable electronic device may assign the maximum gradation weight to the first gradation value and thus acquire a fifth gradation value. In case that the configured range of weights is, for example, 0.5 (minimum) to 2 (maximum), the portable electronic device may acquire a fifth gradation value greater than the first gradation value by multiplying the first gradation value by 2 (maximum). In response to a touch input by a finger received from the display, the portable electronic device may display the drawing 863 to which the fifth gradation value is applied on the display. While the maximum gradation weight is configured, the portable electronic device may acquire a third inclination value corresponding to state (e) (e.g., 45-degree inclination) from the second smart ring 802. The portable electronic device may configure the gradation of the drawing to a third gradation value (e.g., the maximum gradation value) corresponding to the third inclination value. The portable electronic device may assign the maximum gradation weight to the third gradation value and thus acquire the sixth gradation value. In response to a touch input received from the display, the portable electronic device may display the drawing 864 to which the sixth gradation value is applied on the display.

According to the above-described examples, the object to which weights are assigned is the attribute of the drawing (e.g., thickness, transparency, bleed, or gradation). In some embodiments of the disclosure, the object to which weights are assigned may be data (e.g., a pressure value or an inclination value) acquired through a sensor. For example, referring again to FIG. 8B, the portable electronic device may acquire a second pressure value corresponding to state (b) (e.g., fully stretched state) from the first smart ring 801. The portable electronic device may acquire a third pressure value by assigning the weight (e.g., minimum) configured by the user using the first scroll bar 851 to the second pressure value. The portable electronic device 603 may determine the thickness of the drawing to be a seventh thickness value corresponding to the third pressure value. In response to a touch input received from the display, the portable electronic device 803 may display the drawing to which the seventh thickness value is applied on the display.

Numerical values of the above-described weights are merely examples and are not limiting factors for the embodiments of the disclosure. For example, various values may be applied to the weights according to the configuration of the user or the manufacturer.

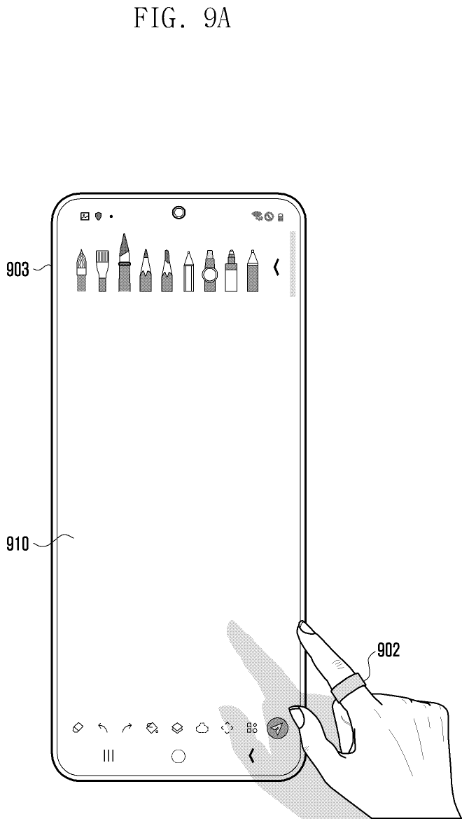

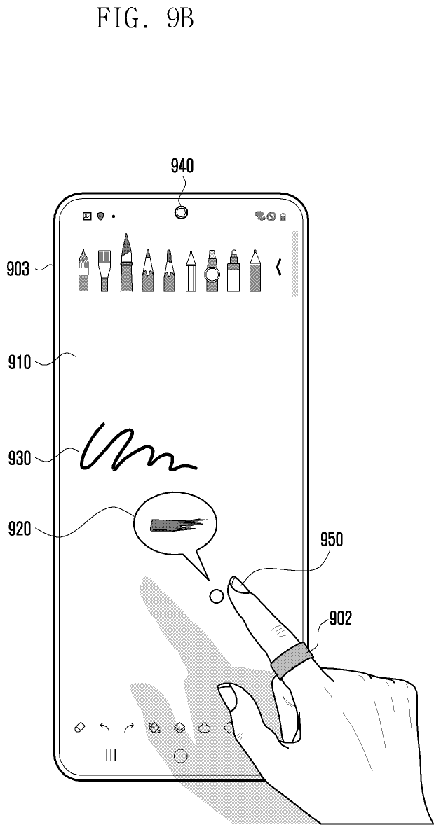

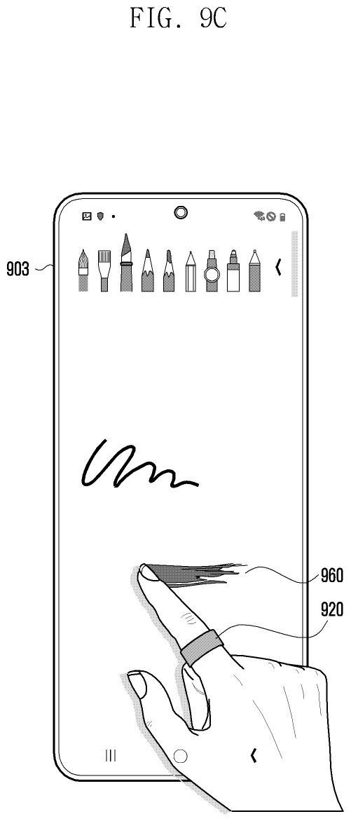

FIGS. 9A, 9B, and 9C are diagrams illustrating operations for supporting a drawing preview in a portable electronic device according to various embodiments of the disclosure.

Referring to FIG. 9A, the portable electronic device 903 (e.g., the portable electronic device 303 in FIG. 3) may display an execution screen 910 (e.g., the execution screen 710 of FIG. 7A) of an application that supports drawing. The wearable device 902 (e.g., the second wearable device 302 in FIG. 3) may be worn on a finger and wirelessly connected to the portable electronic device 903.

Referring to FIG. 9B, the portable electronic device 903 may identify the strength of a signal received from the wearable device 902 through a wireless communication circuit (e.g., a BT communication circuit). Based on the identified signal strength being equal to or greater than a designated strength threshold, the portable electronic device 903 may display a user interface (UI) (in other words, preview) 920 such that the user can preview the new drawing to which a first attribute value (e.g., thickness and/or transparency) and/or a second attribute value (e.g., bleed and/or gradation) are applied. For example, the portable electronic device 903 may display a UI 920 on an execution screen 910 such that the user can preview the density (color)/thickness of the brush to which a writing pressure and a writing angle are applied. The portable electronic device 930 may apply the first attribute value and/or the second attribute value to the UI (default preview) according to the type of tool (e.g., brush, pen, eraser, or the like) selected by the user to generate (e.g., synthesize or render) the UI 920.

According to an embodiment of the disclosure, the portable electronic device 903 may identify the strength of a signal received from the wearable device 902 through a wireless communication circuit (e.g., a BT communication circuit). The portable electronic device 903 may calculate a distance value corresponding to the distance between the two devices 902 and 903, based on the identified signal strength, and may display the UI 920, based on the calculated distance value being equal to or smaller than a designated distance threshold.

According to an embodiment of the disclosure, the portable electronic device 903 may display the UI 920 at a location adjacent to the existing drawing 960. In some embodiments of the disclosure, the portable electronic device 903 may display the UI 920 in a floating state. The portable electronic device 903 may also display the UI 20 at a designated location (e.g., at the top or edge of the screen) of the execution screen 910.

According to an embodiment of the disclosure, the portable electronic device 903 may include a camera 940 having a lens facing in the same direction as the display for displaying the execution screen 910. The camera 940 may be an under-display camera (UDC) which is disposed under the display. Based on the confirmed signal strength being equal to or greater than a designated strength threshold, the processor of the portable electronic device 903 may activate the camera 940 and identify a designated object (e.g., a ring-type wearable device or the tip of a finger) from the image received from the camera 940. In case that the object identification result confirms that the wearable device 902 is worn on a finger, the processor may display the UI 920 at a location adjacent to the tip 950 of the finger.

Referring to FIG. 9C, in response to a touch input, the portable electronic device 903 may display the drawing 960 to which the attribute corresponding to the preview 920 (see FIG. 9B) is applied.

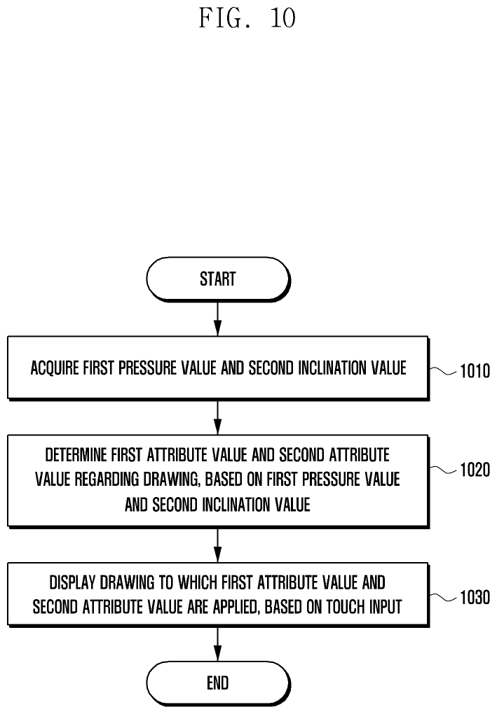

FIG. 10 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 10.

In operation 1010, the portable electronic device may acquire a first pressure value and a first inclination value. According to an embodiment of the disclosure, the portable electronic device may receive data related to a first pressure value from a first wearable device through a wireless communication circuit and may receive data related to a first inclination value from a second wearable device. For example, the first wearable device may provide raw data acquired from a pressure sensor to the portable electronic device. The portable electronic device may calculate the first pressure value by using the received raw data. As another example, the first wearable device may calculate a first pressure value by using raw data and provide the same to the portable electronic device. The second wearable device may provide raw data acquired from the inclination sensor to the portable electronic device. The portable electronic device may calculate the inclination value (e.g., the angle indicating the degree to which the second wearable device is inclined with respect to the gravity direction) by using the received raw data. As another example, the second wearable device may calculate angular velocities and/or accelerations corresponding to the x-axis, y-axis, and z-axis, respectively, by using raw data, and may provide the acceleration values and/or angular velocity values to the portable electronic device. The portable electronic device may calculate the inclination value by using the provided acceleration values and/or angular velocity values. As another example, the second wearable device may calculate the inclination value using the acceleration values and/or angular velocity values, and may provide the inclination value to the portable electronic device.

In operation 1020, the portable electronic device may determine a first attribute value and a second attribute value regarding the drawing, based on the first pressure value and the first inclination value. According to an embodiment of the disclosure, the portable electronic device may determine a first attribute value including the thickness and/or transparency of the drawing, based on the first pressure value. The portable electronic device may determine a second attribute value including the bleed and/or gradation of the drawing, based on the first inclination value. As an example, the portable electronic device may increase line width of the brush in proportion to the first pressure value. As another example, the portable electronic device may increase the transparency of the line in proportion to the first pressure value. As another example, in case that the selected brush is a paintbrush, the portable electronic device may increase the degree to which the paintbrush stroke spreads in proportion to the first inclination value. As another example, the portable electronic device may increase the degree to which the attribute (e.g., tone) of the drawing changes in proportion to the first inclination value. In an embodiment of the disclosure, the portable electronic device may also determine a bleed value, based on the first pressure value, not the first inclination value.

In operation 1030, based on a touch input received from the display, the portable electronic device may display the drawing to which the first attribute value and the second attribute value are applied on the display.

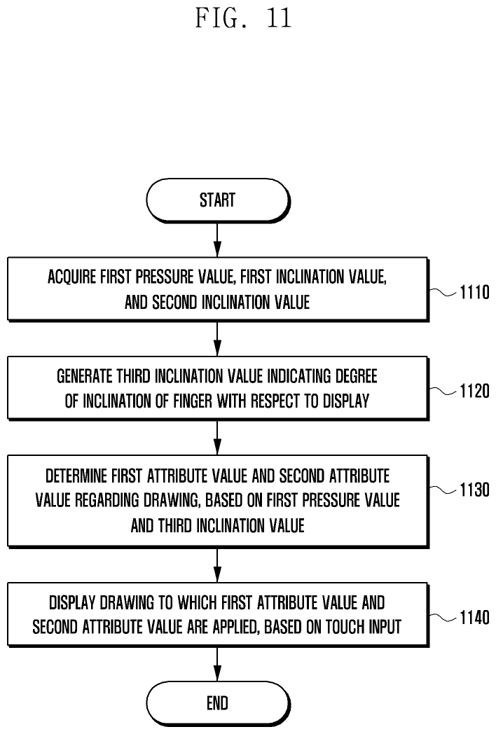

FIG. 11 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic to perform the operations in FIG. 11. Descriptions already made with reference to FIG. 10 will be abbreviated or omitted.

In operation 1110, the portable electronic device may acquire a first pressure value, a first inclination value, and a second inclination value. According to an embodiment of the disclosure, the portable electronic device may receive data related to a first pressure value from the first wearable device through the wireless communication circuit and may receive data related to a first inclination value from the second wearable device. The portable electronic device may acquire a second inclination value (e.g., an angle indicating the degree to which the portable electronic device is inclined with respect to the direction of gravity) from the data received from the sensor (e.g., the third inclination sensor).

In operation 1120, the portable electronic device may generate a third inclination value indicating the degree to which a finger is inclined with respect to the display by using the first inclination value and the second inclination value (e.g., by subtracting the first inclination value from the second inclination value).

In operation 1130, the portable electronic device may determine a first attribute value and a second attribute value regarding the drawing, based on the first pressure value and the third inclination value. According to an embodiment of the disclosure, the portable electronic device may determine a first attribute value including the thickness and/or transparency of the drawing, based on the first pressure value. Based on the third inclination value, the portable electronic device may determine a second attribute value including the bleed and/or gradation of the drawing. In an embodiment of the disclosure, the portable electronic device may also determine the bleed value, based on the first pressure value, not the third inclination value.

In operation 1140,, based on a touch input received from the display, the portable electronic device may display the drawing to which the first attribute value and the second attribute value are applied on the display.

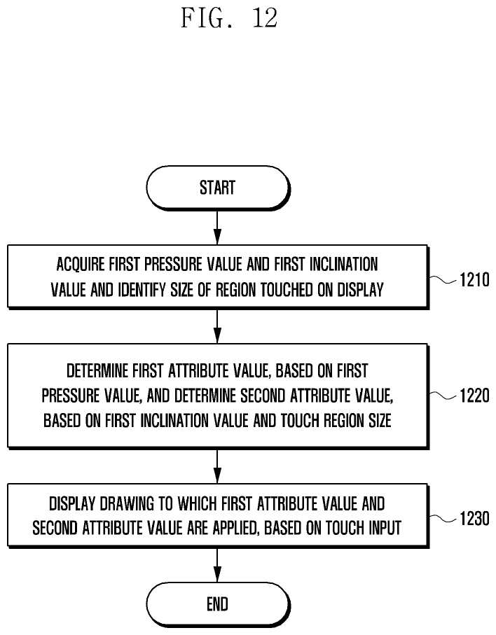

FIG. 12 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 12. Descriptions already made with reference to FIGS. 10 and 11 will be abbreviated or omitted.

In operation 1210, the portable electronic device may acquire a first pressure value and a first inclination value. According to an embodiment of the disclosure, the portable electronic device may receive data related to a first pressure value from the first wearable device through a wireless communication circuit and may receive data related to a first inclination value from the second wearable device. In addition, the portable electronic device may identify information regarding the size of the region touched on the display from the display.

In operation 1220, the portable electronic device may determine a first attribute value related to the drawing, based on the first pressure value. In addition, the portable electronic device may determine a second attribute value regarding the drawing, based on the first inclination value and the size of the touch region. According to an embodiment of the disclosure, the portable electronic device may determine a first attribute value including the thickness and/or transparency of the drawing, based on the first pressure value. The portable electronic device may determine a second attribute value including the bleed and/or gradation of the drawing, based on the first inclination value and the size of the touch region. As an example, in case that the selected brush is a paintbrush, the portable electronic device may increase the degree to which the brush stroke spreads in proportion to the first inclination value and the touch region size. As another example, the portable electronic device may increase the degree to which the attribute (e.g., tone) of the drawing changes in proportion to the first inclination value and the size of the touch region. In an embodiment of the disclosure, the portable electronic device may determine a bleed value, based on the first pressure value, instead of the first inclination value and the touch region size.

In operation 1230, the portable electronic device may display the drawing to which the first attribute value and the second attribute value are applied on the display, based on a touch input received from the display.

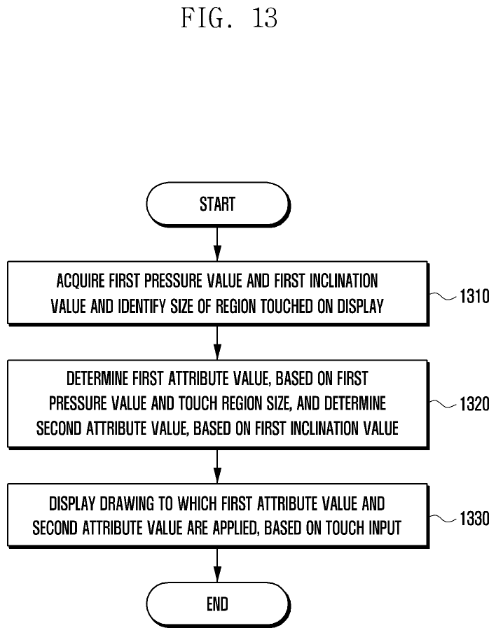

FIG. 13 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 13. Descriptions already made with reference to FIGS. 10, 11, and 12 will be abbreviated or omitted.

In operation 1310, the portable electronic device may acquire a first pressure value and a first inclination value. According to an embodiment of the disclosure, the portable electronic device may receive data related to the first pressure value from a first wearable device through a wireless communication circuit and receive data related to the first inclination value from a second wearable device. In addition, the portable electronic device may identify information on the size of the region touched on the display from the display.

In operation 1320, the portable electronic device may determine a first attribute value regarding the drawing, based on the first pressure value and the size of the touch region. In addition, the portable electronic device may determine a second attribute value regarding the drawing, based on the first inclination value. According to an embodiment of the disclosure, the portable electronic device may determine a first attribute value including the thickness and/or transparency of the drawing, based on the first pressure value and the touch region size. As an example, the portable electronic device may increase the line width of the brush in proportion to the first pressure value and the size of the touch region. As another example, the portable electronic device may increase the transparency of the line in proportion to the first pressure value and the touch region size. The portable electronic device may determine a second attribute value including the bleed and/or gradation of the drawing, based on the first inclination value. In an embodiment of the disclosure, the portable electronic device may determine a bleed value, based on the first pressure value (not the first inclination value) and the size of the touch region.

In operation 1330, the portable electronic device may display the drawing to which the first attribute value and the second attribute value are applied, based on a touch input received from the display.

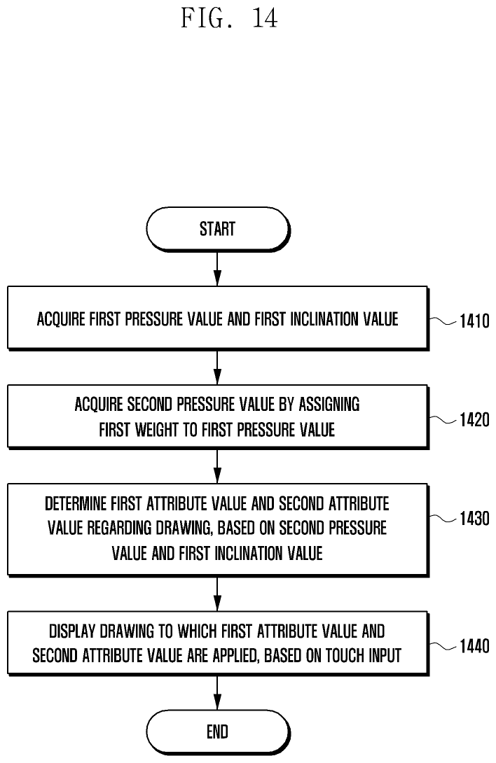

FIG. 14 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 14. Descriptions already made with reference to FIGS. 10 to 13 will be abbreviated or omitted.

In operation 1410, the portable electronic device may acquire a first pressure value and a first inclination value. According to an embodiment of the disclosure, the portable electronic device may receive data related to the first pressure value from the first wearable device through the wireless communication circuit and may receive data related to the first inclination value from the second wearable device.

In operation 1420, the portable electronic device may assign a first weight to the first pressure value and thus acquire a second pressure value. According to an embodiment of the disclosure, the portable electronic device may identify the first weight from weight information configured by the user through a weight configuring menu (e.g., the configuring menu including the first scroll bar 851 and the second scroll bar 852 in FIG. 8A) and stored in the memory.

In operation 1430, the portable electronic device may determine a first attribute value and a second attribute value regarding drawing, based on the second pressure value and the first inclination value. According to an embodiment of the disclosure, the portable electronic device may determine a first attribute value including the thickness and/or transparency of the drawing, based on the second pressure value. The portable electronic device may determine a second attribute value including the bleed and/or gradation of the drawing, based on the first inclination value. In an embodiment of the disclosure, the portable electronic device may determine a bleed value, based on the second pressure value rather than the first inclination value.

In operation 1440, the portable electronic device may display the drawing to which the first attribute value and the second attribute value are applied on the display, based on a touch input received from the display.

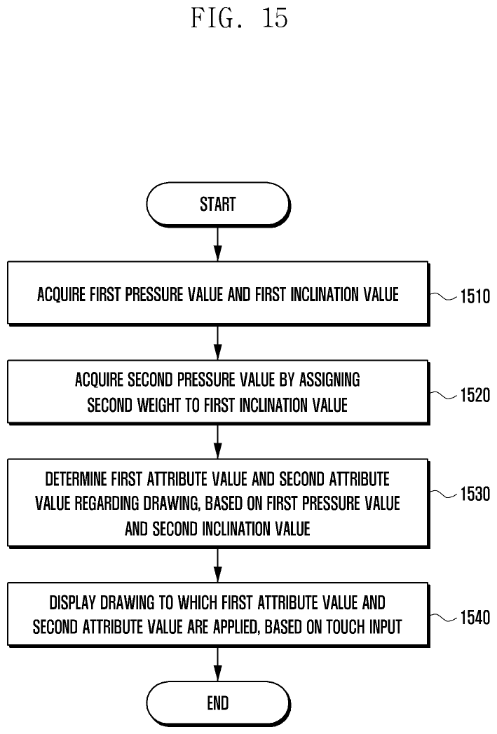

FIG. 15 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 15. Descriptions already made with reference to FIGS. 10 to 14 will be abbreviated or omitted.

In operation 1510, the portable electronic device may acquire a first pressure value and a first inclination value. According to an embodiment of the disclosure, the portable electronic device may receive data related to the first pressure value from the first wearable device through the wireless communication circuit and may receive data related to the first inclination value from the second wearable device.

In operation 1520, the portable electronic device may assign a second weight to the first inclination value and thus acquire a second inclination value. According to an embodiment of the disclosure, the portable electronic device may identify a second weight from weight information configured by the user through a weight configuring menu (e.g., a configuring menu including a third scroll bar 853 and a fourth scroll bar 854) and stored in the memory.

In operation 1530, the portable electronic device may determine a first attribute value and a second attribute value regarding the drawing, based on the first pressure value and the second inclination value. According to an embodiment of the disclosure, the portable electronic device may determine a first attribute value including the thickness and/or transparency of the drawing, based on the first pressure value. The portable electronic device may determine a second attribute value including the bleed and/or gradation of the drawing, based on the second inclination value. In an embodiment of the disclosure, the portable electronic device may also determine the bleed value, based on the first pressure value, not the second inclination value.

In operation 1540, the portable electronic device may display the drawing to which the first attribute value and the second attribute value are applied, based on a touch input received from the display.

According to an embodiment of the disclosure, the portable electronic device may determine a first attribute value regarding the drawing, based on the second pressure value acquired in operation 1420. The portable electronic device may also determine a second attribute value, based on the second inclination value acquired in operation 1520. Based on a touch input received from the display, the portable electronic device may display the drawing to which the first attribute value and the second attribute value are applied on the display.

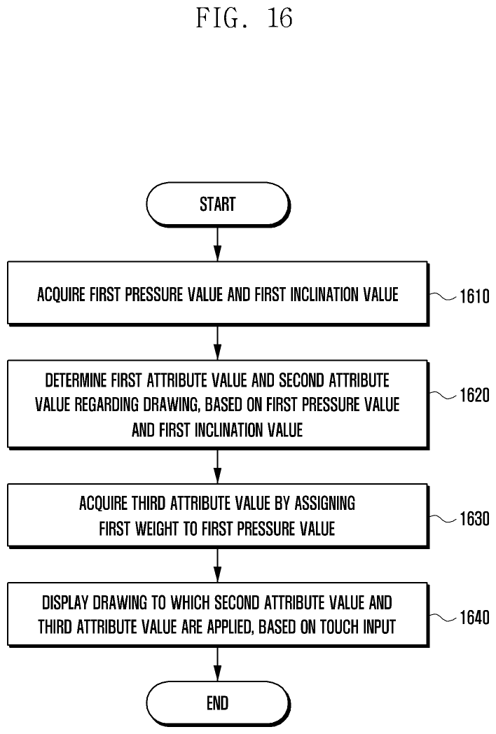

FIG. 16 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 16. Descriptions already made with reference to FIGS. 10 to 15 will be abbreviated or omitted.

In operation 1610, the portable electronic device may acquire a first pressure value and a first inclination value. According to an embodiment of the disclosure, the portable electronic device may receive data related to the first pressure value from the first wearable device through the wireless communication circuit and receive data related to the first inclination value from the second wearable device.

In operation 1620, the portable electronic device may determine a first attribute value and a second attribute value regarding the drawing, based on the first pressure value and the first inclination value. According to an embodiment of the disclosure, the portable electronic device may determine a first attribute value, including the thickness and/or transparency of the drawing, based on the first pressure value. The portable electronic device may determine a second attribute value including the bleed and/or gradation of the drawing, based on the first inclination value. In an embodiment of the disclosure, the portable electronic device may also determine the bleed value, based on the first pressure value, not the first inclination value.

In operation 1630, the portable electronic device may apply a first weight to the first attribute value and thus acquire a third attribute value. According to an embodiment of the disclosure, the portable electronic device may identify a first weight from weight information configured by the user through a weight configuring menu (e.g., a configuring menu including the first scroll bar 851 and the second scroll bar 852 in FIG. 8A) and stored in the memory.

In operation 1640, the portable electronic device may display the drawing to which the second attribute value and the third attribute value are applied on the display, based on a touch input received from the display.

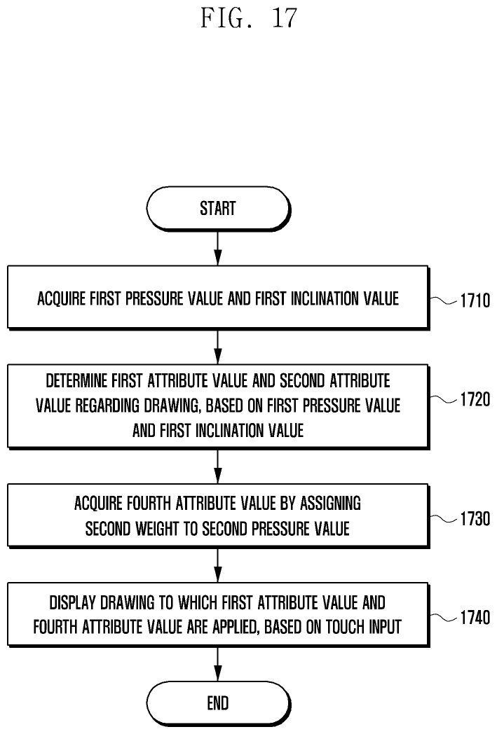

FIG. 17 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 17. Descriptions already made with reference to FIGS. 10 to 16 will be abbreviated or omitted.

In operation 1710, the portable electronic device may acquire a first pressure value and a first inclination value. According to an embodiment of the disclosure, the portable electronic device may receive data related to the first pressure value from the first wearable device through the wireless communication circuit and receive data related to the first inclination value from the second wearable device.

In operation 1720, the portable electronic device may determine a first attribute value and a second attribute value regarding the drawing, based on the first pressure value and the first inclination value. According to an embodiment of the disclosure, the portable electronic device may determine a first attribute value including the thickness and/or transparency of the drawing, based on the first pressure value. Based on the first inclination value, the portable electronic device may determine a second attribute value including the bleed and/or gradation of the drawing. In an embodiment of the disclosure, the portable electronic device may also determine the bleed value, based on the first pressure value, not the first inclination value.

In operation 1730, the portable electronic device may acquire a fourth attribute value by assigning a second weight to the second attribute value. According to an embodiment of the disclosure, the portable electronic device may identify the second weight from weight information configured by the user through a weight configuring menu (e.g., the configuring menu including the third scroll bar 853 and the fourth scroll bar 854 in FIG. 8A) and stored in the memory.

In operation 1740, the portable electronic device may display the drawing to which the first attribute value and the fourth attribute value are applied on the display, based on a touch input received from the display.

According to an embodiment of the disclosure, the portable electronic device may display the drawing to which the third attribute value acquired in operation 1630 and the fourth attribute value acquired in operation 1730 are applied, on the display, based on a touch input.

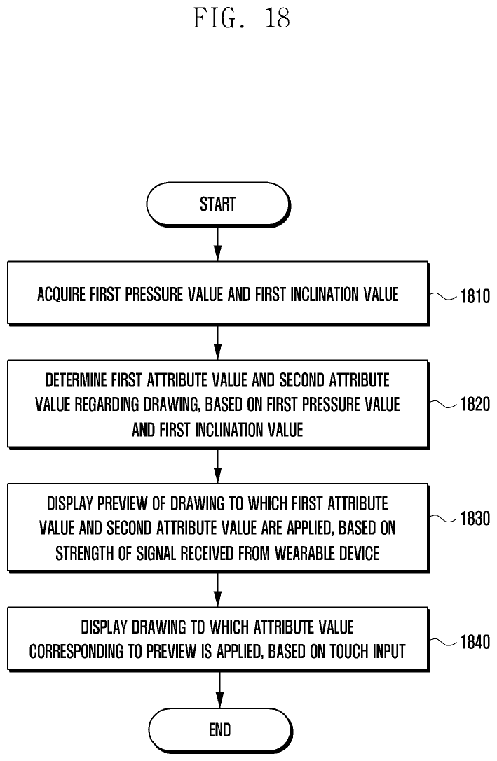

FIG. 18 is a flowchart illustrating operations of a portable electronic device for a drawing according to an embodiment of the disclosure. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 18. Descriptions already made with reference to FIGS. 10 to 17 will be abbreviated or omitted.

In operation 1810, the portable electronic device may acquire a first pressure value and a first inclination value. According to an embodiment of the disclosure, the portable electronic device may receive data related to the first pressure value from the first wearable device through the wireless communication circuit and receive data related to the first inclination value from the second wearable device.

In operation 1820, the portable electronic device may determine a first attribute value and a second attribute value regarding the drawing, based on the first pressure value and the first inclination value. According to an embodiment of the disclosure, the portable electronic device may determine a first attribute value including the thickness and/or transparency of the drawing, based on the first pressure value. The portable electronic device may determine a second attribute value including the bleed and/or gradation of the drawing, based on the first inclination value. In an embodiment of the disclosure, the portable electronic device may also determine a bleed value, based on the first pressure value, not the first inclination value.

In operation 1830, the portable electronic device may display a preview (e.g., UI 920 in FIG. 9B) of the drawing to which the first attribute value and the second attribute value are applied, based on the strength of a signal received from the wearable device. According to an embodiment of the disclosure, the portable electronic device may identify the strength of a signal received from the wearable device 902 through a wireless communication circuit (e.g., a BT communication circuit). Based on the identified signal strength being equal to or greater than a designated signal threshold value, the portable electronic device 903 may display a preview. According to an embodiment of the disclosure, the portable electronic device 903 may calculate a distance value corresponding to the interval between the portable electronic device and the wearable device, based on the identified signal strength, and may display a preview, based on the calculated distance value being equal to or smaller than a designated distance threshold.

In operation 1840, the portable electronic device may display the drawing to which the attribute values applied to the preview is applied on the display, based on a touch input received from the display.

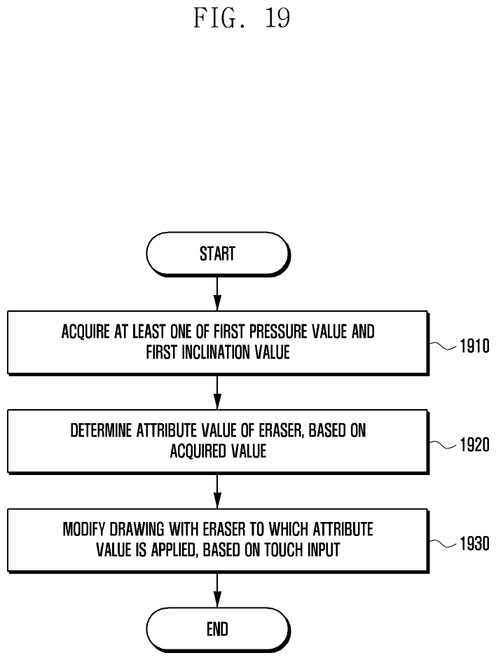

FIG. 19 is a flowchart illustrating operations of a portable electronic device for modifying a drawing according to an embodiment. The portable electronic device may be, for example, the electronic device 101 in FIG. 1 or the portable electronic device 303 in FIG. 3. The instructions stored in the memory of the portable electronic device, when executed by the processor of the portable electronic device, may cause the portable electronic device to perform the operations in FIG. 19. The operations in FIG. 19 may be performed when an eraser is selected by the user, instead of a brush, from the menu provided through the execution screen of an application that supports drawing.

In operation 1910, the portable electronic device may acquire at least one of a first pressure value and a first inclination value. According to an embodiment of the disclosure, the portable electronic device may receive data related to the first pressure value from the first wearable device through the wireless communication circuit and may receive data related to the first inclination value from the second wearable device.

In operation 1920, the portable electronic device may determine an attribute value of the eraser, based on the acquired value. According to an embodiment of the disclosure, the portable electronic device may determine an attribute value related to the area of the eraser, based on the first inclination value. In addition, the portable electronic device may determine an attribute value related to the strength of the eraser, based on the first pressure value. As an example, the portable electronic device may configure the erased region of the drawing to be larger in proportion to the first inclination value. As another example, the portable electronic device may configure the strength of the eraser to be higher in proportion to the first pressure value. The higher the strength, the fewer the number of touch inputs required to erase the corresponding drawing (e.g., a drawing made with a pen or a paintbrush). If a relatively low strength is configured, the corresponding drawing may become blurred but may not be erased.

In operation 1930, the portable electronic device may modify the drawing displayed on the display by using the eraser to which the attribute value is applied, based on a touch input received from the display.

According to an embodiment of the disclosure, the portable electronic device may acquire a second inclination value (e.g., the angle between the y-axis and the z-axis, referring to FIG. 4) from data received from a sensor (e.g., a third inclination sensor). The portable electronic device may generate a third inclination value indicating the relative angle of a finger with respect to the display by using the first inclination value and the second inclination value (e.g., by subtracting the first inclination value from the second inclination value). The portable electronic device may also determine the attribute value regarding the area of the eraser, based on the third inclination value.

According to an embodiment of the disclosure, the portable electronic device may acquire a second pressure value by applying a weight assigned to a first pressure value. According to an embodiment of the disclosure, the portable electronic device may identify a weight associated with pressure from weight information configured by the user through a weight configuring menu and stored in the memory. The portable electronic device may determine an attribute value related to the strength of the eraser, based on the second pressure value.

According to an embodiment of the disclosure, the portable electronic device may acquire a second inclination value by assigning a designated weight to the first inclination value. According to an embodiment of the disclosure, the portable electronic device may identify the weight associated with the inclination from weight information configured by the user through a weight configuring menu and stored in the memory. The portable electronic device may determine the attribute value regarding the area of the eraser, based on the second inclination value.

According to an embodiment of the disclosure, the portable electronic device may make a modification by assigning a designated weight to the attribute value regarding the strength of the eraser. According to an embodiment of the disclosure, the portable electronic device may identify a weight associated with the strength of the eraser from weight information configured by the user through a weight configuring menu and stored in the memory. The portable electronic device may modify the drawing displayed on the display by using an eraser to which the modified strength attribute value is applied, based on a touch input received from the display.

According to an embodiment of the disclosure, the portable electronic device may make a modification by assigning a designated weight to the attribute value regarding the area of the eraser. According to an embodiment of the disclosure, the portable electronic device may identify a weight associated with the area of the eraser from weight information configured by the user through a weight configuring menu and stored in the memory. The portable electronic device may modify the drawing displayed on the display by using an eraser to which the modified area attribute value is applied, based on a touch input received from the display.

According to an embodiment of the disclosure, a portable electronic device (e.g., a portable electronic device 303) includes a touch-sensitive display, a wireless communication circuit, a processor, and memory configured to store instructions. The instructions, when executed by the processor, may cause the portable electronic device to receive data related to a pressure value from a first wearable device (e.g., a first wearable device 301) through the wireless communication circuit and receive and data related to a first inclination value from a second wearable device (e.g., a second wearable device 302). The instructions, when executed by the processor, may cause the portable electronic device to, based on the pressure value, determine a first attribute value regarding at least one of the thickness of a drawing and the transparency of the drawing. The instructions, when executed by the processor, may cause the portable electronic device to, based on the first inclination value, determine a second attribute value regarding the gradation of the drawing. The instructions, when executed by the processor, may cause the portable electronic device to, based on a touch input received from the display, display a drawing to which the first attribute value and the second attribute value are applied, on the display.

The portable electronic device may further include a sensor configured to generate data regarding the inclination of the portable electronic device. The instructions, when executed by the processor, may cause the portable electronic device to generate a second inclination value indicating the degree of inclination of the portable electronic device by using data received from the sensor. The instructions, when executed by the processor, may cause the portable electronic device to generate a third inclination value indicating the degree to which a finger is inclined with respect to the display by using the first inclination value and the second inclination value. The instructions, when executed by the processor, may cause the portable electronic device to determine the second attribute value, based on the third inclination value.

The instructions, when executed by the processor, may cause the portable electronic device to identify the size of a touch region on the display, based on the touch input. The instructions, when executed by the processor, may cause the portable electronic device to determine the second attribute value, based on the pressure value and the size of the touch region.

The instructions, when executed by the processor, may cause the portable electronic device to acquire information regarding the size of a touch region on the display, based on the touch input. The instructions, when executed by the processor, may cause the portable electronic device to determine the first attribute value, based on the first inclination value and the size of the touch region.

The instructions, when executed by the processor, may cause the portable electronic device to displaying an icon on the display. The instructions, when executed by the processor, may cause the portable electronic device to, in response to a touch input regarding the icon, display a list of wearable devices on the display. The instructions, when executed by the processor, may cause the portable electronic device to, based on a touch input regarding the list, configure the first wearable device and the second wearable device among the wearable devices on the list.

The instructions, when executed by the processor, may cause the portable electronic device to, after the first wearable device and the second wearable device on the list are configured, display a UI screen for configuring a first weight on the display. The instructions, when executed by the processor, may cause the portable electronic device to receive a first user input through the UI screen. The instructions, when executed by the processor, may cause the portable electronic device to, based on the first user input, configure the first weight. The instructions, when executed by the processor, may cause the portable electronic device to assign the configured first weight to the first attribute value or the pressure value.

The instructions, when executed by the processor, may cause the portable electronic device to, after the first wearable device and the second wearable device on the wearable device list are configured, display a UI screen for configuring a second weight on the display. The instructions, when executed by the processor, may cause the portable electronic device to receive a second user input through the UI screen. The instructions, when executed by the processor, may cause the portable electronic device to configure the second weight, based on the second user input. The instructions, when executed by the processor, may cause the portable electronic device to assign the configured second weight to the second attribute value or the first inclination value.

The instructions, when executed by the processor, may cause the portable electronic device to, in response to the first wearable device being connected to the portable electronic device through the wireless communication circuit, or in response to an application supporting the drawing being executed display the icon on the display.

The instructions, when executed by the processor, may cause the portable electronic device to identify the strength of a signal received by wireless communication circuit from the first wearable device or the second wearable device from the wireless communication circuit. The instructions, when executed by the processor, may cause the portable electronic device to, based on the strength of the signal being equal to or greater than a designated strength threshold, display a preview of a drawing to which the first attribute value and the second attribute value are applied on the display.

The instructions, when executed by the processor, may cause the portable electronic device to, based on the location of a drawing displayed on the display and/or image data acquired from a camera of the portable electronic device, determine the location at which the preview is to be displayed on the display. The instructions, when executed by the processor, may cause the portable electronic device to display the preview at the determined location.

The instructions, when executed by the processor, may cause the portable electronic device to determine a bleed value of the drawing, based on the pressure value or the first inclination value. The instructions, when executed by the processor, may cause the portable electronic device to display a drawing to which the determined bleed value is applied on the display.

According to an embodiment of the disclosure, a method for operating a portable electronic device (e.g., a portable electronic device 303) may include an operation of receiving data related to a pressure value from a first wearable device (e.g., a first wearable device 301) through a wireless communication circuit of the portable electronic device and receiving data related to a first inclination value from a second wearable device (e.g., a second wearable device 302). The method may include an operation of determining a first attribute value regarding at least one of the thickness of a drawing and the transparency of the drawing, based on the pressure value. The method may include an operation of determining a second attribute value regarding the gradation of the drawing, based on the first inclination value. The method may include an operation of, based on a touch input received from a touch-sensitive display of the portable electronic device, displaying a drawing to which the first attribute value and the second attribute value are applied on the display.

The method may include an operation of displaying an icon on the display. The method may include an operation of, in response to a touch input regarding the icon, displaying a list of wearable devices on the display. The method may include an operation of configuring the first wearable device and the second wearable device among wearable devices on the list, based on a touch input regarding the list.

The method may include an operation of, after the first wearable device and the second wearable device on the list are configured, displaying a UI screen for configuring a first weight on the display. The method may include an operation of receiving a first user input through the UI screen. The method may include an operation of configuring the first weight, based on the first user input. The method may include an operation of assigning the configured first weight to the first attribute value or the pressure value.

According to an embodiment of the disclosure, a non-transitory recording medium storing instructions readable by a processor of a portable electronic device, (e.g., a portable electronic device 303) is provided. The instructions, when executed by the processor, may cause the electronic device to receive data related to a pressure value from a first wearable device (e.g., a first wearable device 301) through a wireless communication circuit of the portable electronic device and receiving data related to a first inclination value from a second wearable device (e.g., a second wearable device 302). The instructions, when executed by the processor, may cause the electronic device to determine a first attribute value regarding at least one of the thickness of a drawing and the transparency of the drawing, based on the pressure value. The instructions, when executed by the processor, may cause the electronic device to determine a second attribute value regarding the gradation of the drawing, based on the first inclination value. The instructions, when executed by the processor, may cause the electronic device to, based on a touch input received from a touch-sensitive display of the portable electronic device, display a drawing to which the first attribute value and the second attribute value are applied on the display.

According to an embodiment of the disclosure, a portable electronic device (e.g., the portable electronic device 303 in FIG. 3) includes a touch-sensitive display, a wireless communication circuit, a processor, and memory configured to store instructions. The instructions, when executed by the processor, may cause the portable electronic device to receive data related to a pressure value from a first wearable device through the wireless communication circuit and receive and data related to an inclination value from a second wearable device. The instructions, when executed by the processor, may cause the portable electronic device to determine an attribute value of an eraser, based on at least one of the inclination value and the pressure value. The instructions, when executed by the processor, may cause the portable electronic device to modify a drawing displayed on the display by using an eraser to which the attribute value is applied, based on a touch input received from the display.

In the above description, the prefixes “first,” “second,” “third,” etc., are for the purpose of distinguishing elements with the same name and are not intended to imply any particular significance, such as importance or order, on their own.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A portable electronic device comprising:
a touch-sensitive display;
a wireless communication circuit;
memory, comprising one or more storage media, storing instructions; and
at least one processor communicatively coupled to the touch-sensitive display, the wireless communication circuit, and the memory,
wherein the instructions, when executed by the at least one processor individually or collectively, cause the portable electronic device to:
receive data related to a pressure value from a first wearable device through the wireless communication circuit and receive and data related to a first inclination value from a second wearable device,
based on the pressure value, determine a first attribute value regarding at least one of a thickness of a drawing and a transparency of the drawing,
based on the first inclination value, determine a second attribute value regarding gradation of the drawing, and
based on a touch input received from the touch-sensitive display, display a drawing to which the first attribute value and the second attribute value are applied, on the touch-sensitive display.

2. The portable electronic device of claim 1, further comprising a sensor configured to generate data regarding the inclination of the portable electronic device,
wherein the instructions, when executed by the at least one processor individually or collectively, further cause the portable electronic device to:
generate a second inclination value indicating a degree of inclination of the portable electronic device by using data received from the sensor,
generate a third inclination value indicating a degree to which a finger is inclined with respect to the touch-sensitive display by using the first inclination value and the second inclination value, and
determine the second attribute value, based on the third inclination value.

3. The portable electronic device of claim 1, wherein the instructions, when executed by the at least one processor individually or collectively, further cause the portable electronic device to:
identify a size of a touch region on the touch-sensitive display, based on the touch input. and
determine the second attribute value, based on the pressure value and the size of the touch region.

4. The portable electronic device of claim 3, wherein the instructions, when executed by the at least one processor individually or collectively, further cause the portable electronic device to:
acquire information regarding the size of a touch region on the touch-sensitive display, based on the touch input, and
determine the first attribute value, based on the first inclination value and the size of the touch region.

5. The portable electronic device of claim 4, wherein the instructions, when executed by the at least one processor individually or collectively, further cause the portable electronic device to:
display an icon on the touch-sensitive display,
in response to a touch input regarding the icon, display a list of wearable devices on the touch-sensitive display, and
based on a touch input regarding the list, configure the first wearable device and the second wearable device among the wearable devices on the list.

6. The portable electronic device of claim 5, wherein the instructions, when executed by the at least one processor individually or collectively, further cause the portable electronic device to:
after the first wearable device and the second wearable device on the list are configured, display a UI screen for configuring a first weight on the touch-sensitive display,
receive a first user input through the UI screen,
based on the first user input, configure the first weight, and
assign the configured first weight to the first attribute value or the pressure value.

7. The portable electronic device of claim 5, wherein the instructions, when executed by the at least one processor individually or collectively, further cause the portable electronic device to:
after the first wearable device and the second wearable device on the wearable device list are configured, display a UI screen for configuring a second weight on the touch-sensitive display,
receive a second user input through the UI screen,
configure the second weight, based on the second user input, and
assign the configured second weight to the second attribute value or the first inclination value.

8. The portable electronic device of claim 5, wherein the instructions, when executed by the at least one processor individually or collectively, further cause the portable electronic device to, in response to the first wearable device being connected to the portable electronic device through the wireless communication circuit or in response to an application supporting the drawing being executed, display the icon on the touch-sensitive display.

9. The portable electronic device of claim 1, wherein the instructions, when executed by the at least one processor individually or collectively, further cause the portable electronic device to:
identify a strength of a signal received by wireless communication circuit from the first wearable device or the second wearable device from the wireless communication circuit, and
based on the strength of the signal being equal to or greater than a designated strength threshold, display a preview of a drawing to which the first attribute value and the second attribute value are applied on the touch-sensitive display.

10. The portable electronic device of claim 9, wherein the instructions, when executed by the at least one processor individually or collectively, further cause the portable electronic device to:
based on a location of a drawing displayed on the touch-sensitive display and/or image data acquired from a camera of the portable electronic device, determine a location at which the preview is to be displayed on the touch-sensitive display, and
display the preview at the determined location.

11. The portable electronic device of claim 1, wherein the instructions, when executed by the at least one processor individually or collectively, further cause the portable electronic device to:
determine a bleed value of the drawing, based on the pressure value or the first inclination value, and
display a drawing to which the determined bleed value is applied on the touch-sensitive display.

12. A method for operating a portable electronic device, the method comprising:
receiving data related to a pressure value from a first wearable device through a wireless communication circuit of the portable electronic device and receiving data related to a first inclination value from a second wearable device,
determining a first attribute value regarding at least one of a thickness of a drawing and a transparency of the drawing, based on the pressure value,
determining a second attribute value regarding gradation of the drawing, based on the first inclination value, and
based on a touch input received from a touch-sensitive display of the portable electronic device, displaying a drawing to which the first attribute value and the second attribute value are applied on the touch-sensitive display.

13. The method of claim 12, further comprising:
generating a second inclination value indicating a degree of inclination of the portable electronic device by using data received from a sensor configured to generate data regarding the inclination of the portable electronic device;
generating a third inclination value indicating a degree to which a finger is inclined with respect to the touch-sensitive display by using the first inclination value and the second inclination value; and
determining the second attribute value, based on the third inclination value.

14. The method of claim 12, further comprising:
identifying a size of a touch region on the touch-sensitive display, based on the touch input; and
determining the second attribute value, based on the pressure value and the size of the touch region.

15. The method of claim 14, further comprising:
acquiring information regarding the size of a touch region on the touch-sensitive display, based on the touch input; and
determining the first attribute value, based on the first inclination value and the size of the touch region.

16. The method of claim 12, further comprising:
displaying an icon on the touch-sensitive display;
in response to a touch input regarding the icon, displaying a list of wearable devices on the touch-sensitive display; and
configuring the first wearable device and the second wearable device among wearable devices on the list, based on a touch input regarding the list.

17. The method of claim 16, further comprising:
in response to the first wearable device being connected to the portable electronic device through the wireless communication circuit or in response to an application supporting the drawing being executed, displaying the icon on the touch-sensitive display.

18. The method of claim 16, further comprising:
after the first wearable device and the second wearable device on the list are configured, displaying a UI screen for configuring a first weight on the touch-sensitive display;
receiving a first user input through the UI screen;
configuring the first weight, based on the first user input; and
assigning the configured first weight to the first attribute value or the pressure value.

19. One or more non-transitory computer-readable storage media storing one or more computer programs including computer-executable instructions that, when executed by at least one processor of a portable electronic device individually or collectively, cause the portable electronic device to perform operations, the operations comprising:
receiving data related to a pressure value from a first wearable device through a wireless communication circuit of the portable electronic device and receiving data related to a first inclination value from a second wearable device;
determining a first attribute value regarding at least one of a thickness of a drawing and a transparency of the drawing, based on the pressure value;
determining a second attribute value regarding gradation of the drawing, based on the first inclination value; and
based on a touch input received from a touch-sensitive display of the portable electronic device, displaying a drawing to which the first attribute value and the second attribute value are applied on the touch-sensitive display.

20. The one or more non-transitory computer-readable storage media of claim 19, the operations further comprising:
displaying an icon on the touch-sensitive display;
in response to a touch input regarding the icon, displaying a list of wearable devices on the touch-sensitive display; and
configuring the first wearable device and the second wearable device among wearable devices on the list, based on a touch input regarding the list.
